(19) United States
(12) Patent Application Publication
(10) Pub. No.: US 2025/0185028 A1
(43) Pub. Date: Jun. 5, 2025

(54) MITIGATING PHYSICAL SIDELINK FEEDBACK CHANNEL DISRUPTION DUE TO LTE-V2X AND NR-V2X COEXISTENCE

(71) Applicant: Nokia Technologies Oy, Espoo (FI)

(72) Inventors: Nuno Manuel KIILERICH PRATAS, Aalborg (DK); Daniel MEDINA, Munich (DE); Torsten WILDSCHEK, Gloucester (GB); Vinh VAN PHAN, Oulu (FI); Faranaz SABOURI-SICHANI, Aalborg (DK); Ling YU, Espoo (FI); Jari Olavi LINDHOLM, Espoo (FI)

(21) Appl. No.: 18/842,168

(22) PCT Filed: Feb. 28, 2023
(86) PCT No.: PCT/EP2023/054904

§ 371 Date: Aug. 28, 2024

Related U.S. Application Data
(60) Provisional application No. 63/318,446, filed on Mar. 10, 2022.

(51) Int. Cl. H04W 72/25; H04B 17/318; H04L 1/1867

(52) U.S. Cl. CPC H04W 72/25; H04B 17/328; H04L 1/1896

(57) ABSTRACT

Embodiments of the present disclosure relate to mechanisms for identifying and overcoming overlaps in LTE-V2X and NR-V2X sidelink resources for sidelink communications. In example embodiments, a user equipment performs sensing of reserved resources in both a first sidelink radio access technology resource pool and a second sidelink radio access technology resource pool. Based on the sensing, forming at least one candidate resource set identifying all resources that are free to be used by the first radio access technology resource pool, based on the indication that these are not being used for transmission by at least one other user equipment of the first sidelink radio access technology resource pool and identifying for each of the resources in the at least one candidate resource set corresponding resources to be used for a physical sidelink feedback channel of the first sidelink radio access technology resource pool. Based on the sensing, exclude from the at least one candidate resource set all the resources for which the physical sidelink feedback channel resource is identified to be reserved for the transmission by the at least one other user equipment of the first sidelink radio access technology resource pool and select a resource to be used for the transmission of a physical sidelink control channel and physical sidelink shared channel from the at least one candidate resource set.

### TECHNICAL FIELD

The teachings in accordance with the exemplary embodiments of this invention relate generally to identifying and overcoming overlaps in LTE-V2X and NR-V2X sidelink resources for sidelink communications.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

| | |
|---|---|
| SCI | Sidelink Control Information |
| TX | Transmitter |
| RX | Receiver |
| PRB | Physical Resource Block |
| HARQ | Hybrid Automatic Repeat Request |
| PSFCH | Physical Sidelink Feedback Channel |
| PSSCH | Physical Sidelink Shared Channel |
| PSCCH | Physical Sidelink Control Channel |
| V2X | Vehicle-to-Everything |
| RSRP | Reference Signal Received Power |
| ITS | Intelligent Transport Systems |
| CAM | Cooperative Awareness Message |
| BSM | Basic Safety Message |
| SPS | Semi Persistent Scheduling |
| SC-FDMA | Single-Carrier Frequency-Division Multiple Access |
| OFDM | Orthogonal Frequency Division Multiplex |
| DMRS | DeModulation Reference Signal |
| TB | Transport Block |
| MCS | Modulation and Coding Scheme |
| SA | Scheduling Assignment |
| QPSK | Quadrature Phase Shift Keying |
| QAM | Quadrature Amplitude Modulation |
| AGC | Automatic Gain Control |

It is noted that there is demand for high-capacity and high-speed data processing, as well as a variety of services using and connection of wireless terminals such as in vehicles (arial or ground) or in sites, and the like. Accordingly, there is demand for technology including sidelink communications technologies for high-speed and high-capacity telecommunications systems grown out of simple voice-centric services and able to process a variety of scenarios and high-capacity data, such as wireless data, machine-type communication data, and sidelink communication data to name only a few.

Example embodiments of this invention disclosure relates to methods and apparatus to improve sidelink related services and resource allocations in sidelink wireless communications.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a deployment band configuration for C-V2X at 5.9 GHz in Europe;

FIG. 2 shows a deployment band configuration for C-V2X at 5.9 GHz in Europe;

FIG. 3A shows examples of LTE-V2X and NR-V2X co-channel coexistence in the same carrier;

FIG. 3B shows a table with examples of fully overlapped NR-V2X resource pool into LTE-V2X resource pool;

FIG. 4 shows LTE SL resource allocation modes: (a) Mode 3; (b) Mode 4;

FIG. 5 shows an LTE-V2X (subframe) slot format for the PSSCH and PSCCH;

FIG. 6 shows LTE-V2X channelization, with adjacent and non-adjacent PSCCH+PSSCH;

FIG. 7 shows NR SL resource allocation modes: (a) Mode 1; (b) Mode 2;

FIG. 8A shows a Table 1 of 2^{nd} stage SCI formats;

FIG. 8B shows a Table 2 of 2^{nd} stage SCI formats;

FIG. 9A shows SL slot format: (a) slot with PSCCH/PSSCH; (b) slot with PSCCH/PSSCH and PSFCH;

FIG. 9B shows PSSCH DMRS configurations based on the number of used symbols and duration of the PSCCH;

FIG. 10 shows SL slot with PSCCH/PSSCH and PSFCH;

FIG. 11 shows PSSCH to PSFCH mapping;

FIG. 12 shows example of an LTE-V2X resource pool overlapping with an NR-V2X resource pool;

FIG. 13 shows dual sensing, where the vehicle is assumed to have both LTE and NR modules and is able to perform simultaneous sensing, and where the overlapping LTE-V2X and NR-V2X resource pools are being sensed simultaneously;

FIG. 14 shows an example of LTE sidelink transmissions interfering with NR PSFCH resources due to overlap;

FIG. 15 shows a procedure from the TX point of view in accordance with example embodiments of the invention;

FIG. 16 shows a procedure from the RX point of view in accordance with example embodiments of the invention; and

FIG. 17 shows a high level block diagram of various devices used in carrying out various aspects of the invention;

FIG. 18A, FIG. 18B, FIG. 18C and FIG. 18D each show a method in accordance with example embodiments of the invention which may be performed by an apparatus

### DETAILED DESCRIPTION

In example embodiments of the invention there is proposed a method which can be performed by an apparatus to identify and overcome overlaps in LTE-V2X and NR-V2X sidelink resources for sidelink communications.

### Spectrum Regulation

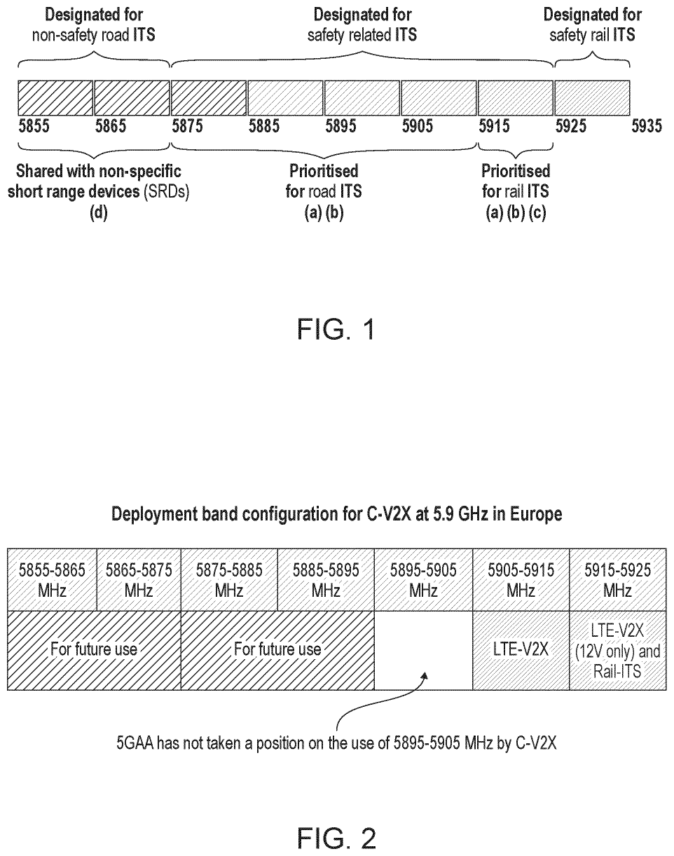

European administrations have designated the bands 5855-5875 MHz and 5875-5925 MHz—referred to as the 5.9 GHz band—for use by road Intelligent Transport Systems (ITS). Industry is planning for the deployment of C-V2X (LTE-V2X and NR-V2X) technologies for direct communications (via the PC5 interface) in the 5.9 GHz band, as depicted in FIG. 1.

Where the following aspects should be considered in relation to FIG. 1:
a) No harmful interference shall be caused to the application having priority;
b) Road-ITS and rail-ITS shall remain confined to their respective prioritized frequency range until such time when appropriate spectrum sharing solutions are defined by ETSI (but see (c));
c) Vehicle-to-vehicle (V2V) communications for road-ITS may only be permitted at 5915-5925 MHz once spectrum sharing solutions for the protection of rail ITS have been developed at ETSI. In the absence of such sharing solutions for the protection of rail-ITS, national administrations may permit infrastructure-to-vehicle (I2V) communications for road-ITS at 5915-5925 MHz subject to coordination with rail-ITS; and/or
d) Use of spectrum in the frequency range 5855-5875 MHz is on a noninterference/non-protected basis, and includes use by non-safety road-ITS and non-specific short range devices.

In the deployment band configuration proposed by 5GAA for C-V2X at 5.9 GHz in Europe, LTE-V2X is constrained to the 5905-5915 MHz and 5915-5925 MHz bands. The remaining spectrum is expected to be made available to NR-V2X.

Additionally, 5GAA noted the challenges associated with the impact of inter-technology coexistence on safety. Namely, “there is an ongoing coexistence work item at ETSI to investigate the viability of co-channel coexistence between LTE-V2X and ITS-G5 in the 5.9 GHz band. Such co-existence will inevitably negatively impact the ability of the two technologies to deliver safe and reliable communications; and will potentially also impact the specifications of the technologies and the complexity of the products.”

### 3GPP Standardization Background

In standards at the time of this application objectives have been approved to enable LTE-V2X and NR-V2X coexistence, with the following justification:

Another aspect to consider is the V2X deployment scenario where both LTE V2X and NR V2X devices are to coexist in the same frequency channel. For the two different types of devices to coexist while using a common carrier frequency, it is important that there is mechanism to efficiently utilize resource allocation by the two technologies without negatively impacting the operation of each technology.

In standards at the time of this application, RAN studied and introduced the in-device coexistence framework for NR SL—the outcome of the related RAN4 work was studied for standards acceptance at the time of the invention. From that study, the following mechanisms were introduced:
TDM based:
   Synchronization/subframe boundary alignment is needed between LTE and NR sidelink
   Long term time-scale TDM operation:
      LTE SL and NR SL resource pools are configured to not overlap in time domain=>No specification impact
   Short term time-scale TDM operation:
      For TX/TX and TX/RX overlap, if packet priorities of both LTE and NR sidelink transmissions/receptions are known to both RATs prior to time of transmission subject to processing time restriction, then the packet with a higher relative priority is transmitted/received;
      Equal priority TX/TX or TX/RX is up to UE implementation
      RX/RX case is up to UE implementation
      Prioritization details:
         The priority of PSFCH is the same as the corresponding PSSCH
         The priorities of LTE PSBCH and NR S-SSB are (pre-)configured
         If multiple NR SL transmissions/receptions overlap with single LTE SL TX/RX, the highest priority NR SL TX/RX determines the priority of the NR SL
FDM based:
   Static frequency allocation between NR and LTE SL
   Synchronization is not needed between NR and LTE if frequency separation between LTE and NR is large enough
   Static power allocation, which implies that full UE TX power is used only when LTE and NR SL are transmitted simultaneously

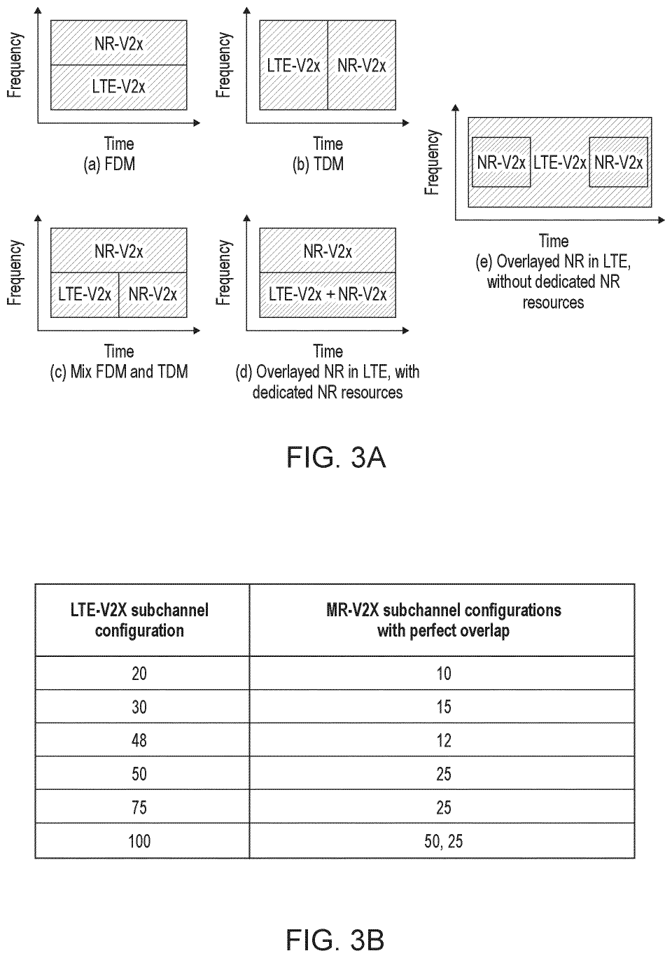

Note that the objective in standards at the time of this application is to go beyond in-device coexistence and focus on co-channel coexistence, i.e., the coexistence between different devices (UEs) in the same radio resources/carrier frequency. In FIG. 3A, there is presented some examples of coexistence of LTE-V2X and NR-V2X in the same radio resources.

From a resource use point of view, it is well known that dynamic spectrum sharing, as in the examples depicted in FIG. 3A (d) and (e), is more flexible and enables higher efficiency. However, these schemes have the drawback of being more complex due to the ancillary mechanisms that enable their coexistence with other systems. In contrast, static spectrum sharing options, as those depicted in FIG. 3A (a), (b) and (c), are simpler. It can also be anticipated that FIG. 3A (e) may be the only available option in practice, as the LTE-V2X devices may be configured to occupy the entire bandwidth and NR-V2X devices will need to be able to adapt to that in order to be able to access the ITS band. However, considering potential difficulties to modify pre-configuration and it may be better to allow NR V2X UE use all the available resources, so that there are no dedicated resources for LTE (or NR) but the same resources are available for both i.e. complete overlap.

As no enhancement is expected from LTE-V2X point of view to enable this sharing, even no change or reconfiguration may be expected to the resource pool configurations associated with the LTE-V2X device. Instead it is expected that all effort will have to be done from the NR-V2X device point of view, therefore dynamic spectrum sharing schemes become the only viable solution for LTE-V2X and NR-V2X coexistence.

Furthermore, as more vehicles are introduced into the market, the more critical it will become to support advanced V2X use cases that require NR-V2X to operate. At the same time, since CAM (or BSM) can be both sent using LTE-V2X or NR-V2X, then as time progresses, it is expected that more and more vehicles will utilize NR-V2X and less LTE-V2X. Therefore, by enabling LTE-V2X and NR-V2X to coexist in the same resources, then this will enable a soft re-farming of the LTE-V2X resources. In contrast, if instead static TDM or FDM deployments are considered for LTE-V2X and NR-V2X, this will imply that the resources associated with LTE-V2X will remain allocated potentially for several decades without NR-V2X being able to use those resources. Of course, for this to make sense, NR-V2X will also have to be allowed for safety related ITS.

In the deployment scenario where NR-V2X devices are able to use the same resources (i.e., the example depicted in FIG. 3A (d)), the NR-V2X numerology needs to be contained as perfectly as possible within the LTE-V2X numerology. NR-V2X is expected to be deployed in FR1 with a sub-carrier spacing of 30 kHz, while LTE-V2X has a sub-carrier spacing of 15 kHz. Therefore, in the time-domain, two NR-V2X slots can be contained in one LTE-V2X subframe, while in the frequency domain, an NR-V2X PRB will have twice the bandwidth of an LTE-V2X PRB. Both LTE-V2X and NR-V2X SL resources are organized into resource pools, which in the time domain are organized into slots (NR-V2X) or subframes (LTE-V2X), while in the frequency domain these are organized into subchannels composed by a number of PRBs. The configurable number of PRBs for LTE-V2X and NR-V2X are as follows:
LTE-V2X: 4, 5, 6, 8, 9, 10, 12, 15, 16, 18, 20, 25, 30, 48, 50, 72, 75, 96, 100; and
NR-V2X: 10, 12, 15, 20, 25, 50, 75, 100.

So, assuming a perfect overlap between an LTE-V2X resource pool and one (or more) NR-V2X resource pools, there could be the following pairing of configurations, as depicted in Table 1 of FIG. 3B. Note that this is just an example, but in practice, as there will be multiple LTE-V2X resource pools, it is possible to achieve any number of LTE-V2X and NR-V2X resource pools. The only important aspect is that the LTE-V2X and NR-V2X PRBs are aligned both in time and frequency.

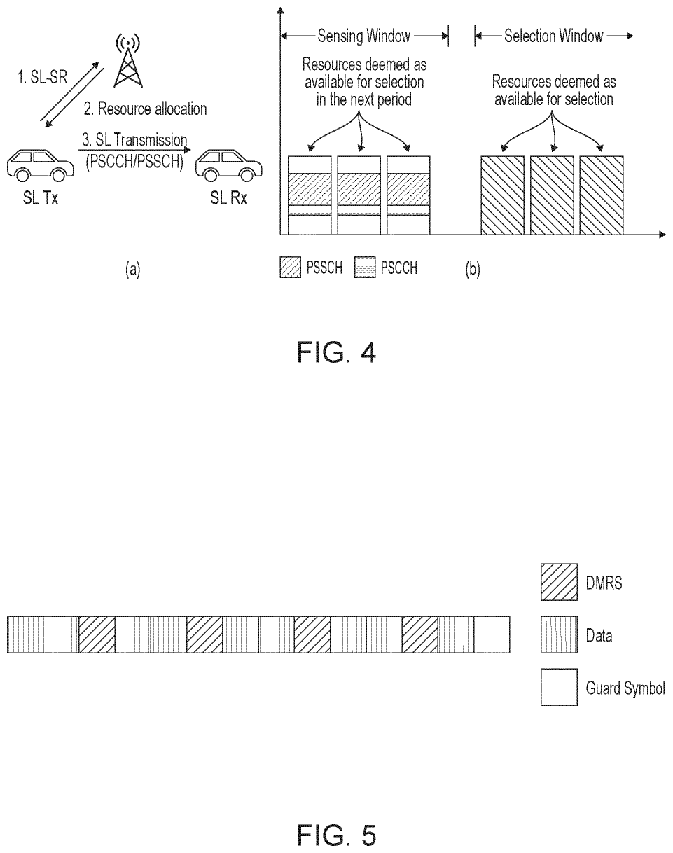

LTE-V2X standards at the time of this application have been designed to facilitate vehicles to communicate with other nearby vehicles via direct/SL communication. Communications between these vehicles can take place in LTE-V2X using either mode 3 or mode 4, which are depicted in FIG. 4

When in mode 3, the sidelink radio resources are scheduled by the base station or evolved NodeB (eNB), hence, it is only available when vehicles are under cellular coverage.

When in mode 4, the vehicles autonomously select their sidelink radio resources regardless of whether they are under cellular coverage or not. When the vehicles are under cellular coverage, the network decides how to configure the LTE-V2X channel and informs the vehicles through the LTE-V2X configurable parameters. The message includes the carrier frequency of the LTE-V2X channel, the LTE-V2X resource pool, synchronization references, the channelization scheme, the number of subchannels per subframe, and the number of RBs per subchannel, among other things. When the vehicles are not under cellular coverage, they utilize a preconfigured set of parameters to replace the LTE-V2X configurable parameters. However, the standard does not specify a concrete value for each parameter. The LTE-V2X resource pool indicates which subframes of a channel are utilized for LTE-V2X. The rest of the subframes can be utilized by other services, including cellular communications.

The autonomous resource selection in mode 4 is performed using the sensing and resource exclusion procedure specified in Release 14, where a vehicle reserves the selected subchannel(s) for a number of periodically recurring packet transmissions. This in turn can be sensed by other vehicles, affecting their own resource selection/exclusion decisions.

### Physical Layer

LTE-V2X uses SC-FDMA (Single-Carrier Frequency-Division Multiple Access) and supports 10 MHz and 20 MHz channels. The channel is divided into 180 kHz Resource Blocks (RBs) that correspond to 12 subcarriers of 15 kHz each. In the time domain, the channel is organized into 1 ms subframes.

Each subframe has 14 OFDM symbols with normal cyclic prefix. Nine of these symbols are used to transmit data and four of them (3rd, 6th, 9th, and 12th) are used to transmit demodulation reference signals (DMRSs) for channel estimation and combating the Doppler effect at high speeds. The last symbol is used as a guard symbol for timing adjustments and for allowing vehicles to switch between transmission and reception across subframes. This format is depicted in FIG. 5.

The RBs are grouped into sub-channels. A sub-channel can include RBs only within the same subframe. The number of RBs per sub-channel can vary and is (pre-)configured. Sub-channels are used to transmit data and control information. The data is organized in Transport Blocks (TBs) that are carried in the Physical Sidelink Shared Channel (PSSCH). A TB contains a full packet (e.g., a CAM or a BSM). A TB can occupy one or several subchannels depending on the size of the packet, the number of RBs per sub-channel, and the utilized Modulation and Coding Scheme (MCS). TBs can be transmitted using QPSK, 16-QAM or 64QAM modulations and turbo coding.

Each TB has an associated Sidelink Control Information (SCI) message that is carried in the Physical Sidelink Control Channel (PSCCH). It is also referred to as Scheduling Assignment (SA). An SCI occupies 2 RBs and includes information such as: an indication of the RBs occupied by the associated TB; the MCS used for the TB; the priority of the message that is being transmitted; an indication of whether it is a first transmission or a blind retransmission of the TB; and the resource reservation interval. A blind retransmission refers to a scheduled retransmission or repetition of the TB (i.e., not based on feedback from the receiver). The resource reservation interval specifies when the vehicle will utilize the reserved sub-channel(s) to transmit its next TB. The SCI includes critical information for the correct reception of the TB. A TB cannot be decoded properly if the associated SCI is not received correctly. A TB and its associated SCI must be transmitted always in the same subframe.

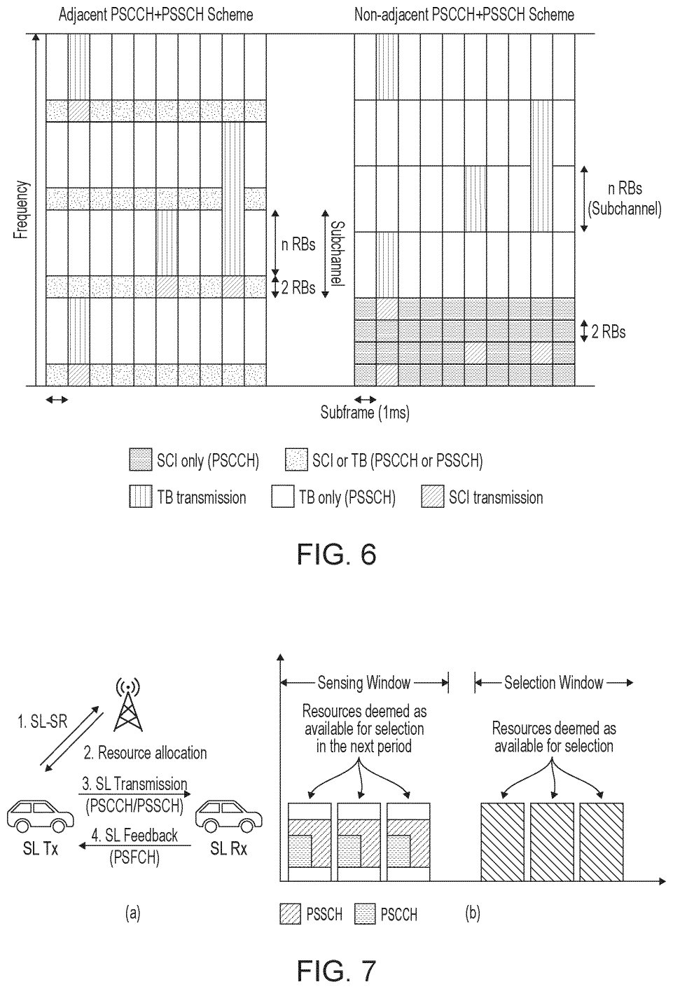

As depicted in FIG. 6, the TB (PSSCH) and its associated SCI (PSCCH) can be transmitted in adjacent or non-adjacent sub-channels, where:
Adjacent PSCCH+PSSCH: The SCI and TB are transmitted in adjacent RBs. For each SCI+TB transmission, the SCI occupies the first two RBs of the first subchannel utilized for the transmission. The TB is transmitted in the RBs following the SCI, and can occupy several subchannels (depending on its size). If it does so, it will also occupy the first two RBs of the following subchannels; and
Nonadjacent PSCCH+PSSCH: The RBs are divided into pools. One pool is dedicated to transmit only SCIs, and the SCIs occupy two RBs. The second pool is reserved to transmit only TBs and is divided into subchannels.

### NR-V2X Overview

In standards at the time of this application NR sidelink (SL) has been designed to facilitate a user equipment (UE) to communicate with other nearby UE(s) via direct/SL communication. Two resource allocation modes have been specified, and a SL transmitter (TX) UE is configured with one of them to perform its NR SL transmissions. These modes are denoted as NR SL mode 1 and NR SL mode 2. In mode 1, a sidelink transmission resource is assigned (scheduled) by the network (NW) to the SL TX UE, while a SL TX UE in mode 2 autonomously selects its SL transmission resources.

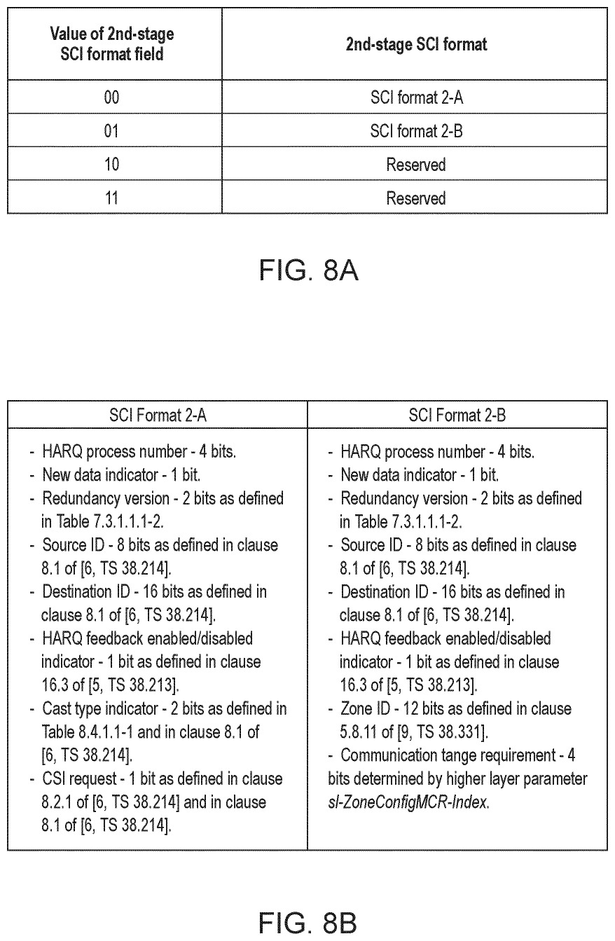

In mode 1, where the gNB is responsible for the SL resource allocation, the configuration and operation is similar to the one over the Uu interface, which is depicted in FIG. 7).

In mode 2, the SL UEs perform autonomously the resource selection with the aid of a sensing procedure. More specifically, a SL TX UE in NR SL mode 2 first performs a sensing procedure over the configured SL transmission resource pool(s), in order to obtain the knowledge of the reserved resource(s) by other nearby SL TX UE(s). Based on the knowledge obtained from sensing, the SL TX UE may select resource(s) from the available SL resources, accordingly. In order for a SL UE to perform sensing and obtain the necessary information to receive a SL transmission, it needs to decode the sidelink control information (SCI). In release 16, the SCI associated with a data transmission includes a 1^{st}-stage SCI and 2ⁿd-stage SCI, and their contents are standardized.

### Sidelink Control Information (SCI)

The SCI follows a 2-stage SCI structure, whose main motivation is to support the size difference between the SCIs for various NR-V2X SL service types (e.g., broadcast, groupcast and unicast).

The 1^{st}-stage SCI, SCI format 1-A, carried by PSCCH and contains:
information to enable sensing operations
information needed to determine resource allocation of the PSSCH and to decode 2^{nd}-stage SCI

SCI format 1-A is used for the scheduling of PSSCH and 2^{nd}-stage-SCI on PSSCH. The following information is transmitted by means of the SCI format 1-A:
Priority—3 bits;
Frequency resource assignment

$$- ⌈ {log}_{2} ( \frac{{N}_{subChannel}^{SL} ( {N}_{subChannel}^{SL} + 1 )}{2} ) ⌉ bits$$

when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits$$

when the value of the higher layer parameter sl-MaxNumPerReserve is configured to 3;
Time resource assignment—5 bits when the value of the higher layer parameter sl-MaxNumPerReserve is configured to 2; otherwise 9 bits when the value of the higher layer parameter sl-MaxNumPerReserve is configured to 3;
Resource reservation period −┌log₂ N_{rsv_period}┐ bits as defined in clause 8.1.4 of [6, TS 38.214], where N_{rsv_period} is the number of entries in the higher layer parameter sl-ResourceReservePeriodList, if higher layer parameter sl-MultiReserveResource is configured; 0 bit otherwise;
DMRS pattern −┌log₂ Nₚₐₜₜₑᵣₙ┐ bits as defined in standards at the time of this application, where Nₚₐₜₜₑᵣₙ is the number of DMRS patterns configured by higher layer parameter sl-PSSCH-DMRS-TimePatternList; 0 bit if sl-PSSCH-DMRS-TimePatternList is not configured.
2^{nd}-stage SCI format—2 bits;
Beta_offset indicator—2 bits as provided by higher layer parameter sl-BetaOffsets2ndSCI;
Number of DMRS port—1 bit;
Modulation and coding scheme—5 bits;
Additional MCS table indicator—as defined in standards at the time of this application: 1 bit if one MCS table is configured by higher layer parameter sl-Additional-MCS-Table; 2 bits if two MCS tables are configured by higher layer parameter sl-Additional-MCS-Table; 0 bit otherwise;
PSFCH overhead indication—1 bit as defined standards at the time of this application if higher layer parameter sl-PSFCH-Period=2 or 4; 0 bit otherwise;
Reserved—a number of bits as determined by higher layer parameter sl-NumReservedBits, with value set to zero.

FIG. 8A shows a Table 1 of 2^{nd} stage SCI formats.

The 2^{nd}-stage SCI, SCI format 2-A and 2-B, carried by PSSCH (multiplexed with SL-SCH) and contains:
Source and destination identities
information to identify and decode the associated SL-SCH TB
control of HARQ feedback in unicast/groupcast
trigger for CSI feedback in unicast
the contents of the 2^{nd}-stage SCI are provided in Table 2 of FIG. 8B:

The configuration of the resources in the sidelink resource pool defines the minimum information required for a RX UE to be able to decode a transmission, which includes the number of sub-channels, the number of PRBs per sub-channels, the number of symbols in the PSCCH, which slots have a PSFCH and other configuration aspects not relevant to example embodiments of this invention.

However, the details of the actual sidelink transmission (i.e., the payload) is provided in the PSCCH (1^{st}-stage SCI) for each individual transmission, which includes: The time and frequency resources, the DMRS configuration of the PSSCH, the MCS, PSFCH, among others.

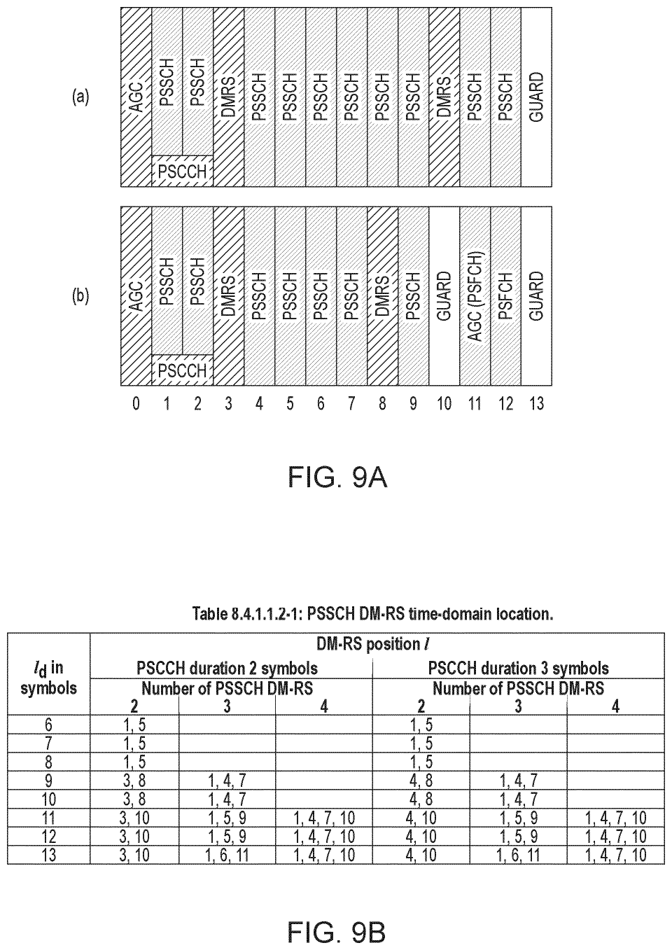

An example of the SL slot structure is depicted in FIG. 9A, where it is shown a slot with PSCCH/PSSCH and a slot with PSCCH/PSSCH where the last symbols are used for PSFCH.

The configuration of the PSCCH (e.g., DMRS, MCS, number of symbols used) is part of the resource pool configuration. Furthermore, the indication of which slots have PSFCH symbols is also part of the resource pool configuration. However, the configuration of the PSSCH (e.g., the number of symbols used, the DMRS pattern and the MCS) is provided by the 1^{st}-stage SCI which is the payload sent within the PSCCH and follows the configuration depicted in FIG. 9B.

### HARQ Procedure

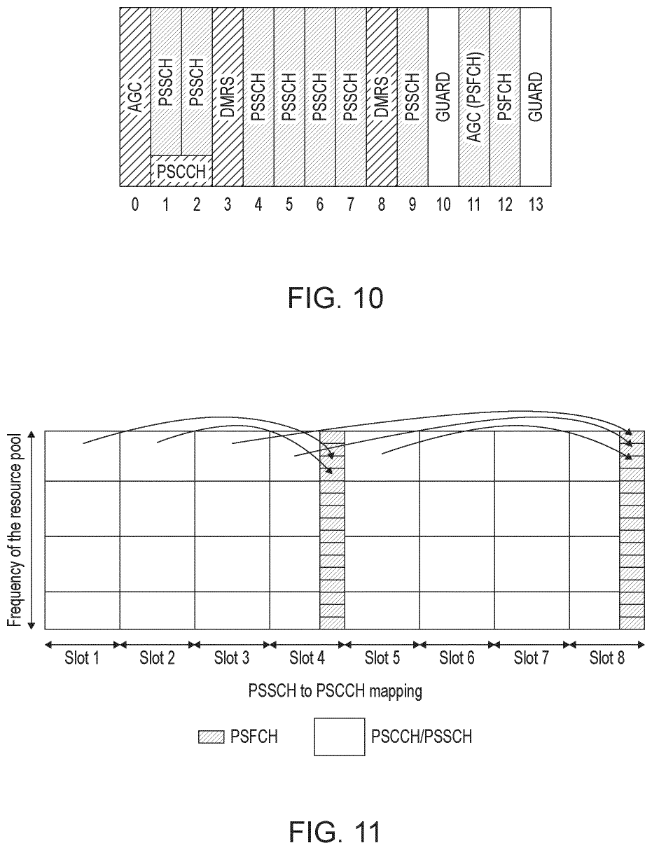

The PSFCH was introduced during Rel-16 to enable HARQ feedback over the sidelink from a UE that is the intended recipient of a PSSCH transmission (i.e., the RX UE) to the UE that performed the transmission (i.e., the TX UE). Within a PSFCH, a Zadoff-Chu sequence in one PRB is repeated over two OFDM symbols, the first of which can be used for AGC, near the end of the sidelink resource in a slot. An example slot format of PSCCH, PSSCH, and PSFCH is provided in FIG. 10. The Zadoff-Chu sequence as base sequence is (pre-)configured per sidelink resource pool.

The time resources for PSFCH are (pre-)configured to occur once every 1, 2, or 4 slots, and the HARQ feedback resource (PSFCH) is derived from the resource location of PSCCH/PSSCH.

For PSSCH-to-HARQ timing, there is a configuration parameter K with the unit of slot. The time occasion for PSFCH is determined from K. For a PSSCH transmission with its last symbol in slot n, HARQ feedback is in slot n+a where a is the smallest integer larger than or equal to K with the condition that slot n+a contains PSFCH resources. As an example illustrated in FIG. 11, the period of PSFCH resources is configured as 4, and K (the sl-MinTimeGapPSFCH) is configured as 3. For a PSSCH transmitted in slot 1 or 2, the time occasion for the corresponding PSFCH is slot 4. PSFCH resources used for HARQ feedback of PSSCH transmissions with the same starting sub-channel in different slots are FDMed. As an example shown in FIG. 11 PSFCH resources for PSSCHs in slot 1 and 2 are FDMed in slot 4.

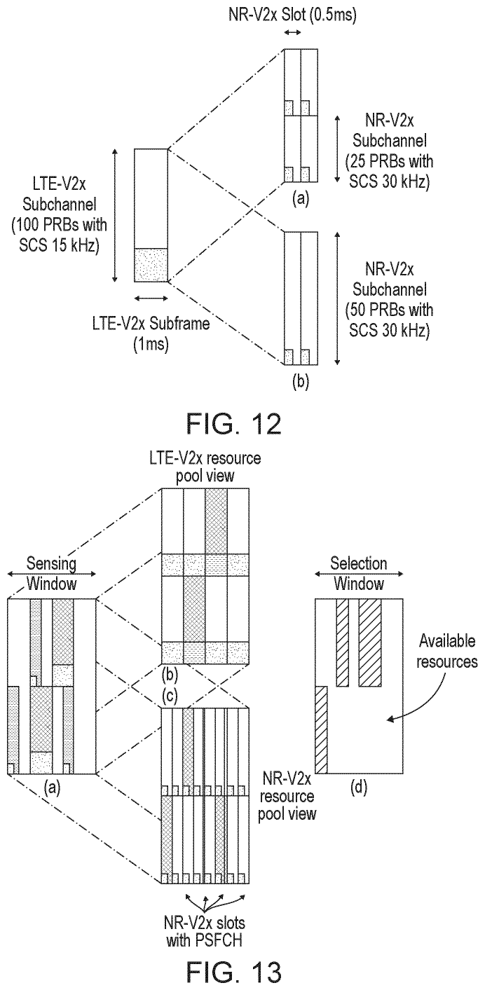

To explain the problem, consider the overlapping of an NR-V2X resource pool onto an LTE-V2X resource pool, as depicted in FIG. 12.

When an NR-V2X resource pool overlaps with an LTE-V2X resource pool, then an NR device, when performing resource selection via mode 2, will have to perform sensing in such a way that it detects the activity of other NR and LTE devices. This means that the NR device will have to monitor the two overlapping resource pools and decode both the LTE SCIs transmitted in the LTE-V2X resource pool and the NR SCIs transmitted in the NR-V2X resource pool. From those SCIs, the NR device becomes aware of future transmissions of other surrounding devices, and from there it can ascertain which resources will be available (i.e., should not be excluded) for its own NR-V2X sidelink transmission(s). This procedure is illustrated in FIG. 13. for the NR overlay configuration depicted in FIG. 12.

In NR sidelink, some PSCCH/PSSCH transmissions (unicast and groupcast) can be configured to request HARQ feedback from the intended receiver. This means that the intended NR receiver, upon decoding the SCI (both 1^{st}-stage SCI and 2^{nd}-stage SCI) associated with the PSCCH/PSSCH transmission, will provide HARQ feedback using the associated PSFCH resource(s).

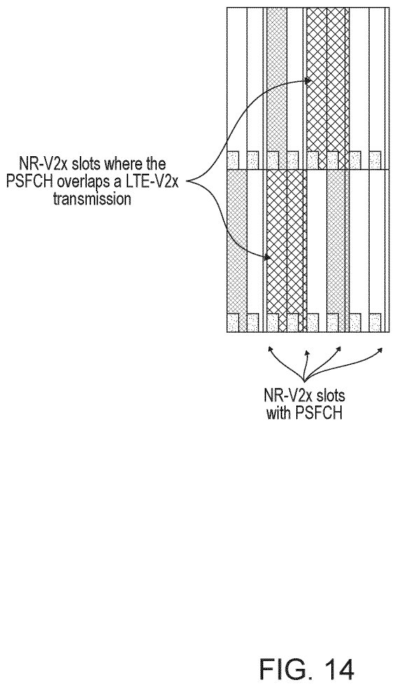

This raises the problem that, when the NR-V2X and LTE-V2X resource pools overlap, the resources where the PSFCH transmissions take place can also overlap with the resources used for LTE sidelink transmissions. This is depicted in FIG. 14. There are configurations which avoid this overlap: If the NR SL SCS is 60 kHz and PSFCH resources are configured every fourth NR slot, then it can be arranged that the PSFCH transmissions take place during the guard period of LTE SL. This, however, is not a preferred configuration since 30 kHz is generally considered the most suitable SCS for NR SL in FR1.

In NR sidelink, sensing takes place from the NR TX point of view and only targets the selection of a resource where the NR TX can perform its NR PSCCH/PSSCH transmission without interfering with other NR PSCCH/PSSCH transmissions. Therefore, it does not take into account whether the associated PSFCH resource will be available or not for the NR RX to provide the HARQ feedback (e.g., due to a transmission from an LTE sidelink device overlapping with the associated PSFCH resource).

Overlap between an NR PSFCH transmission and an LTE SL transmission may result in the following problems:

At the LTE SL RX UE:
Even if the overlap is in time only (i.e., the PRBs for LTE SL and NR PSFCH do not overlap), LTE SL reception may be severely degraded because the RX receive gain of the LTE SL RX UE is assumed to have been set during the first symbol of the LTE subframe. When the NR PSFCH transmission starts, the LTE SL RX UE will receive much higher power, resulting in saturation and clipping in case there is too low frequency separation; and
Additionally, the PSFCH transmission results in additional interference at the LTE SL RX UE, especially if the overlap is in both time and frequency.

At the NR SL TX UE:
PSFCH reception performance may be degraded by interference from the LTE SL transmission, especially if the overlap is in both time and frequency.

Finally, as the LTE SL is targeted for basic road safety, then the LTE SL transmission and reception should be protected. However, this means that the NR SL RX UE will not be able to provide the HARQ feedback. In example embodiments of this invention, this problem is addressed.

For some example embodiments of this invention, it is assumed that the LTE-V2X and NR-V2X sidelink resource pools overlap in both time and frequency (e.g., as depicted in FIG. 13). Then there is considered the case where a vehicle has both LTE-V2X and NR-V2X sidelink modules and that these are connected with each other in such a way that information can be exchanged between both modules, enabling the vehicle to perform simultaneous sensing of LTE-V2X and NR-V2X sidelink resource pools. In particular, the sensing in the LTE-V2X sidelink resource pool allows the NR-V2X sidelink module to identify future LTE-V2X sidelink transmissions.

In accordance with example embodiments of the invention, where there exists an overlap of an NR-V2X resource pool with an LTE-V2X resource pool, an NR device, when performing resource selection via mode 2, will have to perform sensing in such a way that it detects the activity of other NR and LTE devices in its neighbourhood. This means that the NR device may have to monitor the two overlapping resource pools and decode both the LTE SCIs (Sidelink Control Information) transmitted in the LTE-V2X resource pool and the NR SCIs transmitted in the NR-V2X resource pool. From these SCIs, the NR device will then be aware of future transmissions of other surrounding devices, and therefore can determine which resources will be available (i.e., resources that should not be excluded) for its own NR-V2X sidelink transmissions. In addition, in NR sidelink operation, some PSCCH/PSSCH transmissions can be configured to request a HARQ feedback from the intended receiver. This means that the intended NR receiver, upon decoding the SCI associated with the PSCCH/PSSCH transmission, will provide a HARQ feedback using the associated PSFCH (Physical Sidelink Feedback Channel) resources. When now, the NR-V2X and LTE-V2X resource pools overlap, the resources where the PSFCH transmissions take place can also overlap with the resources used for LTE sidelink transmissions.

However, as the NR device will select a resource where it can perform its NR PSCCH/PSSCH transmission without interfering with other NR PSCCH/PSSCH transmissions, it will not consider whether the associated PSFCH resource will be available or not for the NR receiver to provide the HARQ feedback (e.g., due to a transmission from an LTE sidelink device overlapping with the associated PSFCH resource). Such an overlap between an NR PSFCH transmission and an LTE SL transmission can impact the efficiency of the sidelink of both an LTE device and a NR device will suffer from interference and also cause the HARQ feedback not to be transmitted.

In accordance with example embodiments of the invention, there is proposed a mechanism for determining resources that can be used for a NR PSCCH/PSSCH transmission with HARQ feedback. According to the proposed mechanism, a simultaneous sensing of both LTE and NR sidelink resource pools is performed by a device. This is done by the simultaneous decoding of both LTE SCIs and NR SCIs. (The background assumption is that such a device has modules that allow it to use V2X sidelink transmissions both for LTE and NR and that these modules can communicate between them and exchange information). The sensing applied on the LTE sidelink resource pool allows the NR module to identify future LTE-V2X sidelink transmissions and determine resources that are available for NR PSCCH/PSSCH transmissions and be configured to request a HARQ feedback.

The NR-V2X sidelink module utilizes the information from the LTE-V2X sidelink resource pool activity to determine not only which resources are available for NR PSCCH/PSSCH transmissions but also whether NR PSCCH/PSSCH transmissions taking place on those resources can be configured to request HARQ feedback (i.e., by using the NR-V2X sidelink resource pool configuration identifying in which slots and subchannels the PSFCH resources are configured to occur). In practice, this means that the NR-V2X sidelink module, when performing resource exclusion of candidate resources for NR PSCCH/PSSCH transmission based on sensing of both NR-V2X and LTE-V2X sidelink resource pools, identifies:
(i) whether a candidate resource overlaps with a resource indicated as reserved for a future (NR-V2X or LTE-V2X) sidelink transmission, and
(ii) whether the associated PSFCH resource(s) overlap with a resource indicated as reserved for a future LTE-V2X sidelink transmission.

Based on this procedure, the NR-V2X sidelink module can identify candidate resources that can be used for NR PSCCH/PSSCH transmission with HARQ feedback (e.g., candidate resources for which neither of the above conditions (i) and (ii) is met). Candidate resources for which condition (ii) is met, but not condition (i), may be used for NR PSCCH/PSSCH transmissions that do not require HARQ feedback.

However, even in the case where the TX deems that a candidate resource can be used for NR PSCCH/PSSCH transmission with HARQ feedback enabled, there can be a sensing misalignment between the TX and RX. This misalignment can be due to the radio conditions at the RX being different from those at the TX (e.g., due to the hidden node issue), especially if TX and RX are far apart. Therefore, to ensure that the LTE-V2X sidelink transmissions are protected (since the main mission of LTE-V2X is for basic road safety), then it is proposed that the RX vehicle/module will have to be actively sensing the LTE-V2X sidelink resource pool (even when only taking the role of RX) and from there identify if a PSFCH resource can be used or not. This information can then be used by the RX device to determine if it should or not perform the PSFCH transmission in a PSFCH resource associated with a received NR PSCCH/PSSCH transmission.

### Note on Overlapping NR-V2X and LTE-V2X Transmissions

In general, the overlap of NR-V2X and LTE-V2X SL transmissions can occur: i) in time only; or ii) in both time and frequency. In the former case, even though the LTE-V2X and NR-V2X SL transmissions do not overlap in frequency, the transmission of PSFCH in a RB adjacent to a time-overlapping LTE SL transmission might impact LTE reception severely due to RX AGC. However, if the PSFCH is transmitted in a RB that is sufficiently separated in frequency from the LTE-V2X SL transmission, this will no longer be a problem. Therefore, an NR-V2X SL device, when evaluating if a given PSFCH resource may or may not be utilized for PSFCH transmission, should consider also the separation in frequency with respect to a time-overlapping LTE-V2X SL transmission.

In conclusion, a PSFCH resource will be assumed to overlap with an LTE-V2X SL transmission if:
It overlaps in both time and frequency with the LTE-V2X SL transmission; or
It overlaps in time only with the LTE SL transmission but its distance in frequency to the LTE-V2X SL transmission is smaller than X PRBs. Where X is:
   Where X is a function of the performance of an LTE-V2X SL RX filter and NR-V2X SL TX filter, which attenuate emissions outside the transmission bandwidth; or
   X is a gap needed to guarantee that sufficient orthogonality between LTE SL and NR SL can be maintained;
It overlaps in time only with LTE SL transmissions:
   This can be the case since even if the overlap is in time only (i.e., the PRBs for LTE SL and NR PSFCH do not overlap), LTE SL reception may be severely degraded because the RX receive gain of the LTE SL RX UE is assumed to have been set during the first symbol of the LTE subframe. When the NR PSFCH transmission starts, the LTE SL RX UE will receive much higher power, resulting in saturation and clipping.

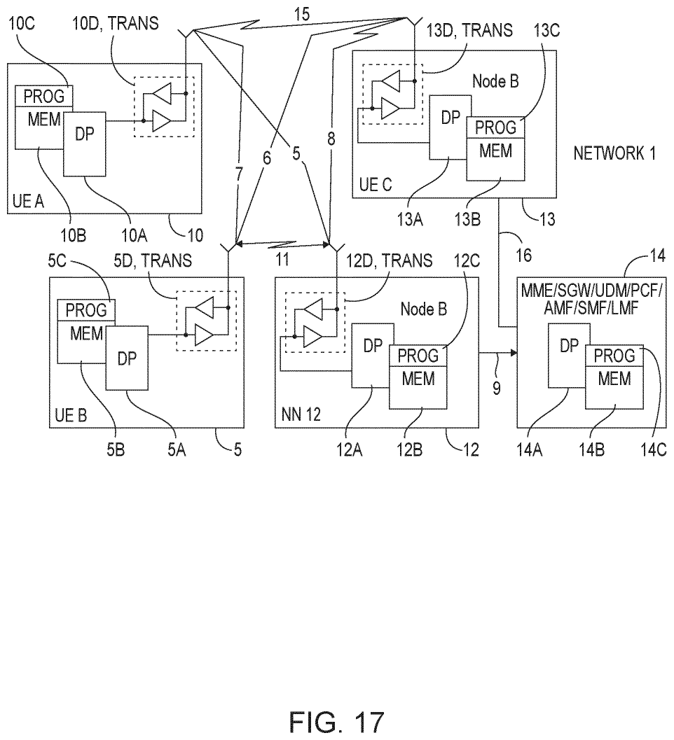

Before describing the example embodiments of the present disclosure in detail, reference is made to FIG. 17 for illustrating a simplified block diagram of various electronic devices of one possible and non-limiting exemplary system that are suitable for use in practicing the example embodiments of the present disclosure.

It is noted that although FIG. 17 shows four UE this is not limiting and performance in accordance with example embodiments of the invention can be applied by any one or more of the UE of FIG. 17.

FIG. 17 shows a block diagram of one possible and non-limiting exemplary system in which the example embodiments of the present disclosure may be practiced. In FIG. 17, a user equipment UE A, a user equipment UE B, a user equipment UE C, and a user equipment NN 12 is in wireless communication with a wireless network 1 or network 1 as in FIG. 17. The wireless network 1 or network 1 as in FIG. 17 can comprise a communication network such as a mobile network e.g., the mobile network 1 or first mobile network as disclosed herein. Any reference herein to a wireless network 1 as in FIG. 17 can be seen as a reference to any wireless network as disclosed herein. Further, the wireless network 1 as in FIG. 17 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded, vehicle-mounted mobile device, or arial device and performs a language signaling and/or data exchange with the RAN.

The UE A (user equipment A) includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to UE B, UE C, and/or NN 12, respectively. The one or more memories MEM 10B include computer program code PROG 10C. The UE A communicates with UE B, UE C, and/or NN 12 via a wireless link 5, 7, or 15, respectively. The one or more memories MEM 10B and the computer program code PROG 10C are configured to cause, with the one or more processors DP 10A, the UE A to perform one or more of the operations as described herein.

The UE B (user equipment B) includes one or more processors DP 5A, one or more memories MEM 5B, and one or more transceivers TRANS 5D interconnected through one or more buses. Each of the one or more transceivers TRANS 5D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 5D which can be optionally connected to one or more antennas for communication to UE A, UE C, and/or NN 12, respectively. The one or more memories MEM 5B include computer program code PROG 5C. The UE B communicates with UE A, UE C, and/or NN 12 via a wireless link 7, 6, or 11, respectively. The one or more memories MEM 5B and the computer program code PROG 5C are configured to cause, with the one or more processors DP 5A, the UE B to perform one or more of the operations as described herein.

The UE C (user equipment C) is a network node that communicates with devices such as NN 12, UE B, and/or UE A of FIG. 17. The UE C can be associated with a mobility function device such as an AMF or SMF, further the UE C may comprise a NR/5G Node B or possibly an evolved NB, a base station such as a master or secondary node base station (e.g., for NR or LTE) that communicates with devices such as the NN 12 and/or UE B and/or UE A in the wireless network 1. The UE C includes one or more processors DP 13A, one or more memories MEM 13B, one or more network interfaces, and one or more transceivers TRANS 12D interconnected through one or more buses. In accordance with the example embodiments these network interfaces of UE C can include X2 and/or Xn interfaces and/or other interfaces for use to perform the example embodiments of the present disclosure. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the UE C to perform one or more of the operations as described herein. The UE C may communicate with the UE A, UE B, and/or NN 12 or any other device using, e.g., at least link 15 and/or link 6. The link, 15, 8, or 6 as shown in FIG. 17 can be used for communication between the UE C and UE A, UE B, and/or NN 12. It is noted that any of the link as disclosed herein can comprise one or more sidelink links. In addition, any of these links.

The NN 12 (NR/5G Node B, an evolved NB, or LTE or NR device) is a network node such as a master or secondary node base station (e.g., for NR or LTE long term evolution) that communicates with devices such as UE A, UE B, and/or UE C of FIG. 17. The NN 12 provides access to wireless devices such as the UE A, UE B, and/or UE C to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn and/or other interfaces for use to perform the example embodiments of the present disclosure. Each of the one or more transceivers TRANS 12D includes a receiver and a transmitter. The one or more transceivers TRANS 12D can be optionally connected to one or more antennas for communication over at least link 11 and/or link 5 and/or link 8. The TRANS 12D can connect with the UE B and/or UE A via links 11 or link 5, respectively. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the UE A, UE B, and/or UE C such as via link 8, 11, and/or 5. Further any of the links as disclosed herein may be wired or wireless or both. Further any of the links as disclosed herein may be configured to be through other network devices such as, but not limited to an SGW/AMF/UPF device such as the MME/SGW/UDM/PCF/AMF/SMF/LMF 14 of FIG. 17. The NN 12 may perform functionalities of a Mobility Management Entity (MME), Serving Gateway (SGW), Unified Data Management (UDM), Policy Control Function (PCF), User Plane Function (UPF), Access and Mobility Management Function (AMF) and/or a Location Management function (LMF) for LTE and similar functionality for 5G and NR.

It is noted that that the UE A, UE B, UE C, and/or NN 12 can be configured (e.g. based on standards implementations etc.) to perform functionality of a Location Management Function (LMF). The LMF functionality may be embodied in either of the UE A, UE B, UE C, and/or NN 12 or may be part of these network devices or other devices associated with these devices. In addition, an LMF such as the LMF of the MME/SGW/UDM/PCF/AMF/SMF/LMF 14 of FIG. 17, as at least described below, can be co-located with the UE A, UE B, UE C, and/or NN 12 such as to be separate from the NN 12 and/or UE C of FIG. 17 for performing operations in accordance with example embodiments of the invention as disclosed herein.

These links, for instances, links 5, 6, 7, 8, 11, 15, 16, and 9 maybe wired or wireless or both and the links and/or other interfaces such as being shown in FIG. 17 or FIG. 17 may implement Xn/X2 e.g., link 8 between the UE A, UE B, UE C, and/or NN 12 can include an X2/Xn interface type link. Further, as stated above any of these links may be through other network devices such as, but not limited to an MME/SGW device such as the MME/SGW/UDM/PCF/AMF/SMF/LMF 14 of FIG. 17. The MME/SGW/UDM/PCF/AMF/SMF/LMF 14 of FIG. 17 may be used to control any functions of any of the devices of the Network 1 as shown in FIG. 17.

The one or more buses of the device of FIG. 17 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D, TRANS 5D, and/or TRANS 10D may be implemented as a remote radio head (RRH), with the other elements of the UE A, UE B, UE C, and/or NN 12 being physically in a different location from the RRH, and one or more buses could be implemented in part as fiber optic cable to connect the other elements of the UE A, UE B, UE C, and/or NN 12 to a RRH for example.

It is noted that although FIG. 17 shows a network nodes Such as UE A, UE B, UE C, and/or NN 12. Any of these nodes can communicate with a different eNodeB or eNB or gNB such as for LTE and/or NR, and would still be configurable to perform example embodiments of the present disclosure.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a MME/SGW/UDM/PCF/AMF/SMF/LMF 14 that may include Mobility Management Entity (MME), and/or Serving Gateway (SGW), and/or Unified Data Management (UDM), and/or Policy Control Function (PCF), and/or Access and Mobility Management Function (AMF), and/or Session Management Function (SMF), and/or Authentication Server Function (AUSF) and/or Location Management Function (LMF) and which provides connectivity with a further network, such as a telephone network and/or a data communications network (e.g., the Internet), and which is configured to perform any 5G and/or NR operations in addition to or instead of other standards operations at the time of this application. The MME/SGW/UDM/PCF/AMF/SMF/LMF 14 is configurable to perform operations in accordance with example embodiments of the present disclosure in any of an LTE, NR, 5G and/or any standards based communication technologies being performed or discussed at the time of this application. In addition, it is noted that the operations in accordance with example embodiments of the present disclosure, as performed by the NN 12 and/or UE C, may also be performed at the MME/SGW/UDM/PCF/AMF/SMF/LMF 14.

Regarding the LMF functionality of the MME/SGW/UDM/PCF/AMF/SMF/LMF 14 of FIG. 17, the LMF receives measurements and assistance information from the communication network and user equipment (UE). This can be via an Access and Mobility Management Function (AMF) over an interface to determine a position of the UE. The UE B and/or the UE A as in FIG. 17 may communicate with the LMF via at least any of links 5, 6, 11, and/or 15. The NN 12 can if necessary then further communicate with the LMF of the MME/SGW/UDM/PCF/AMF/SMF/LMF 14 of FIG. 17 via the link 16 or link 9 as in FIG. 17.

It is noted that the link 16 or link 9 can include any links needed between UE A, UE B, UE C, and/or NN 12, and the MME/SGW/UDM/PCF/AMF/SMF/LMF 14 of FIG. 17 for any of these devices to communicate with at least the LMF of the MME/SGW/UDM/PCF/AMF/SMF/LMF 14 of FIG. 17. Further, it is noted that any of links that are mentioned in this paper can include hardwired links and/or wireless links and, as needed, and/or include any type of interface (e.g., LTE and/or 5G interface) such as but not limited to at least one of an Xn, X2, S1, NG, NG-C, NLs, E1, and/or F1 type interface.

The MME/SGW/UDM/PCF/AMF/SMF/LMF 14 includes one or more processors DP 14A, one or more memories MEM 14B, and one or more network interfaces (N/W I/F(s)), interconnected through one or more buses coupled with at least links 16 and 9. Communication between the NN 12 or UE C and the LMF may be performed via an Access and Mobility Management function (AMF) e.g., of the MME/SGW/UDM/PCF/AMF/SMF/LMF 14. A control plane interface between NN 12 and/or UE C (or a gNB) and AMF can be an NG-C interface and an interface between the AMF and LMF can be NLs. In accordance with the example embodiments these network interfaces can include X2 and/or Xn and/or other interfaces for use to perform the example embodiments of the present disclosure. The one or more memories MEM 14B include computer program code PROG 14C. The one or more memories MEM14B and the computer program code PROG 14C are configured to, with the one or more processors DP 14A, cause the MME/SGW/UDM/PCF/AMF/SMF/LMF 14 to perform or work with the NN 12 or UE C to perform one or more operations which may be needed to support the operations in accordance with the example embodiments of the present disclosure.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, DP5A, and/or DP14A and memories MEM 10B, MEM 12B, MEM 13B, MEM 5B, and/or MEM 14B, and also such virtualized entities create technical effects.

The computer readable memories MEM 12B, MEM 13B, MEM 5B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, MEM 5B, and MEM 14B may be means for performing storage functions. The processors DP10, DP12A, DP13A, DP5A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, DP5A, and DP14A may be means for performing functions, such as controlling the UE A, UE B, NN 12, UE C, and other functions as described herein.

In general, various embodiments of the UE B and/or UE A can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of UE A, UE B or UE C can be used with a UE vehicle, a High Altitude Platform Station, or any other such type node associated with a terrestrial network or any drone type radio or a radio in aircraft or other airborne vehicle. The UE B or UE A can be an anchor UE or a target UE in accordance with example embodiments of the invention.

### TX Proposed Procedure

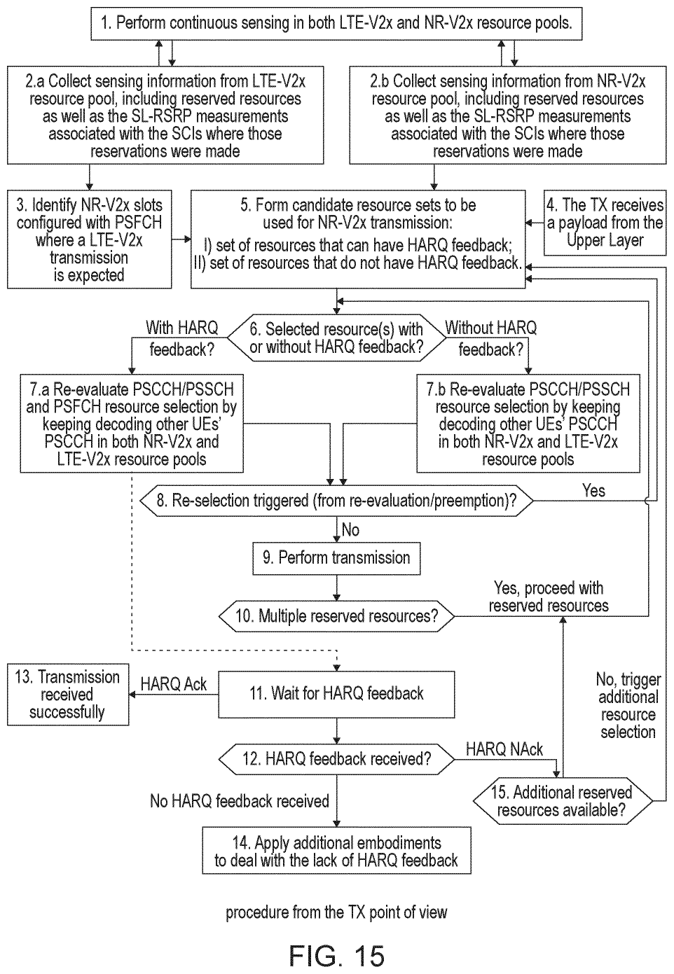

The proposed procedure from the TX point of view is illustrated in FIG. 15. Note that here there is a focus on the transmission of a single TB, which can be transmitted in a single transmission or have multiple retransmissions (either blind retransmissions or retransmissions triggered by received HARQ feedback). The proposed procedure is composed of the following steps:
1. The TX UE performs continuous sensing in both LTE-V2X and NR-V2X sidelink resource pools;
2. The TX UE collects sensing information:
   a. From the LTE-V2X sidelink resource pool, which includes reserved resources (including subframe, initial sub-channel and number of reserved sub-channels) and RSRP measurements (PSSCH-RSRP) associated with the LTE SCIs where those reservations were made;
   b. From the NR-V2X sidelink resource pool, which includes reserved resources (including slot, initial sub-channel and number of reserved sub-channels) and RSRP measurements (PSCCH-RSRP or PSSCH-RSRP, depending on (pre-)configured parameter sl-RS-ForSensing) associated with the NR SCIs where those reservations were made;
3. In accordance with example embodiments of the invention there is identifying NR-V2X SL slots configured with PSFCH where an overlapping LTE PSCCH/PSSCH transmission is expected;
   a. In accordance with example embodiments of the invention a PSFCH resource may be deemed as free (i.e., available) if:
      i. The RSRP measurement according to the received LTE SCI is below an RSRP threshold;
         i. This RSRP threshold can be the same as the one used to determine if a candidate resource is free with respect to an overlapping LTE PSCCH/PSSCH and/or NR PSCCH/PSSCH future transmission, or it can be a separately configured one;
      ii. The PSFCH resource does not overlap with the LTE PSCCH and the RSRP measurement according to the received LTE SCI is below an RSRP threshold, which indicates that the PSFCH reception will not be interfered by the LTE PSSCH transmission;
      iii. The PSFCH resource time is not overlapping with the transmission of a CAM which the NR RX is expected to be receiving using its LTE RX counterpart, i.e. the NR TX tries to select NR PSCCH/PSSCH resources associated with PSFCH resources that do not overlap in time with LTE reception at the NR RX;
4. The TX receives a payload/TB from the Upper Layer;
5. In accordance with example embodiments of the invention candidate resource sets are formed for NR PSCCH/PSSCH transmission:
   a. Set of candidate resources for NR PSCCH/PSSCH transmission with HARQ feedback—this will include all candidate (single-slot) resources not overlapping with a reserved resource, for which the associated PSFCH resource does not overlap with a resource reserved for an LTE PSCCH/PSSCH transmission;
   b. Set of candidate resources for NR PSCCH/PSSCH transmission without HARQ feedback—this will include all candidate (single-slot) resources not overlapping with a reserved resource, for which the associated PSFCH resource overlaps with a resource reserved for an LTE PSCCH/PSSCH transmission;
6. Select a resource from the candidate resource set 5.a or 5.b according to whether the payload/TB requires HARQ feedback;
   a. For example, for broadcast transmissions no HARQ feedback is configured, while for unicast transmissions HARQ feedback may or may not be configured. For groupcast transmissions there is always some form of HARQ feedback configured, otherwise it would have the same effect as broadcast;
   b. In accordance with example embodiments of the invention even if the payload/TB requires HARQ feedback, not every transmission of the payload/TB may need to request HARQ feedback. It may sometimes be better to mix HARQ feedback request/no request for the same TB, e.g., if looking for resources with PSFCH would result in delaying the initial TX;
      i. In one example for the same TB, the first two transmissions can be without HARQ feedback, while the last one can be with HARQ feedback. The order of the transmission of HARQ feedback can change depending on the availability of PSCCH/PSSCH resources with a non-conflicting associated PSFCH;
      ii. In one example, although the payload/TB requires HARQ feedback to be configured, the TX UE decides not to request HARQ feedback if it expects a collision between the associated PSFCH and an LTE PSCCH/PSSCH transmission. In this case, the TX UE may decide to make one or more blind retransmissions.
7. Perform resource re-selection check:
   a. In accordance with example embodiments of the invention when HARQ feedback is configured, evaluate the need to trigger resource re-selection due to either detected conflicts in the PSCCH/PSSCH or the associated PSFCH, by keeping decoding other UEs' PSCCH in both NR-V2X and LTE-V2X sidelink resource pools;
      i. For the case of re-selection check due to resource re-evaluation (i.e., prior to the TX's initial transmission) and to resource preemption (i.e., after the TX's initial transmission), the following applies;
         i. (With respect to the LTE-V2X monitoring in accordance with example embodiments of the invention) The resource re-evaluation of the TX's selected PSCCH/PSSCH resources includes both the evaluation of SCIs (i.e., PSCCH) in the NR-V2X and LTE-V2X sidelink resources pools to check whether its intended transmission is still suitable, taking account of late-arriving SCIs. In the case of NR-V2X, these late-arriving SCIs will typically be associated to an aperiodic higher-priority service starting to transmit after the end of the TX's original sensing window. The RSRP thresholds used to evaluate if the late-arriving SCIs in the NR-V2X and LTE-V2X sidelink resources pools overlap with the TX's selected PSCCH/PSSCH resource can be:
         a. the same for both NR-V2X and LTE-V2X and configured as part of the NR-V2X (pre-)configuration;
         b. different for NR-V2X and LTE-V2X, where the NR-V2X and LTE-V2X RSRPs are separately configured in the NR-V2X (pre-)configuration;
         ii. In accordance with example embodiments of the invention the resource re-evaluation of the TX's selected PSFCH in relation to the activity in the LTE-V2X sidelink resource pool and the associated RSRP threshold to evaluate it can:
         a. use the same RSRP threshold as the PSCCH/PSSCH re-evaluation; or
         b. use a dedicated RSRP threshold for the PSFCH; or
         c. use a RSRP threshold with a delta compared to the RSRP threshold used to the select the candidate single-slot resource (i.e., the PSCCH/PSSCH);
         d. use a RSRP threshold that depends on whether the PSFCH resource overlaps or not with the LTE PSCCH;
         iii. In accordance with example embodiments of the invention the resource re-evaluation of the TX's selected PSFCH to confirm that the PSFCH resource time is not overlapping with the transmission of a CAM which the NR RX is expected to be receiving using its LTE RX counterpart, i.e. the NR TX tries to select NR PSCCH/PSSCH resources associated with PSFCH resources that do not overlap in time with LTE reception at the NR RX;
   b. In accordance with example embodiments of the invention when HARQ feedback is not configured, evaluate the need to trigger resource re-selection due to detected conflicts in the PSCCH/PSSCH by keeping decoding other UEs' PSCCH in both NR-V2X and LTE-V2X sidelink resource pools;
      i. (With respect to the LTE-V2X monitoring in accordance with example embodiments of the invention) Follows the same procedure as in step 7.a.i.i;
8. In case resource re-selection is triggered, then perform again step 5. Otherwise proceed to step 9;
   a. In accordance with example embodiments of the invention, in case the resource re-selection trigger identifies that the PSCCH/PSSCH resource is still valid but the mapped PSFCH is not due to detection of expected LTE PSCCH/PSSCH overlap, then the TX can rebuild the 2^{nd}-stage SCI so that no HARQ feedback is requested for that transmission. This is applicable for the case of resource re-selection check due to reevaluation or preemption;
9. Perform transmission in the selected candidate single-slot resource and with the associated HARQ configuration (i.e., if HARQ feedback is required or not);
   a. In case of multiple reserved resources, this transmission will also indicate the future resources in the 1^{st}-stage SCI;
   b. In accordance with example embodiments of the invention the TX can also indicate in the SCI (i.e., a 1-bit indication on either 1^{st}-stage SCI or 2^{nd}-stage SCI) whether or not the RX should also evaluate if the PSFCH resource is going to overlap with an LTE PSCCH/PSSCH transmission;
      i. The triggering of this indication can be due to the TX detecting the potential for mismatch between the TX and RX radio environment due to:
         i. The TX and RX being separated by a distance above a configured threshold (e.g., based on positioning available from CAMs at the V2X layer);
         ii. The TX's absolute or relative (to the RX) speed (e.g., based on positioning available from CAMs at the V2X layer);
         a. For aperiodic traffic, even with relative speed zero, is very important to have fresh sensing results. In contrast, for periodic traffic, having sensing results is less critical especially in the case where all the surrounding devices only perform periodic transmissions. However, whenever there is a mix of aperiodic and periodic traffic then having fresh sensing results is paramount;
         iii. The current location of the TX (e.g., in an urban scenario there will be a higher likelihood of NLoS conditions than in the case of a highway);
   ii. Another condition can be based on whether the goal is to protect the LTE-V2X transmission (in which case the NR RX UE should be the one to do the assessment of the suitability of the PSFCH) or to protect the NR RX UE reception by ensuring that the transmission of HARQ feedback is possible (in which case it will be more important that the NR TX does the suitability of the PSFCH detection);
10. In case of multiple reserved resources, proceed with the (re)transmission of the TB in those resources;
11. The TX UE, upon performing a transmission with HARQ feedback configured, waits for the reception of the HARQ feedback;
12. If the HARQ feedback was received:
   a. ACK was received, transition to step 13;
   b. NACK was received, transition to step 15;
   c. No HARQ feedback was received, transition to step 14;
13. The transmission was received successfully (i.e., ACK was received), so the TX can close this specific HARQ process;
   a. In case there are any additional reserved resources, the TX UE can reuse them to transmit another TB or in case of no further traffic just drop the reservation(s) (i.e., no further transmission will take place);
14. The HARQ feedback was not received:
   a. In accordance with example embodiments of the invention the TX monitors (even after re-evaluation) whether or not there was an LTE PSCCH/PSSCH transmission overlapping with the associated PSFCH resource(s).
      i. If there is no LTE PSCCH/PSSCH transmission, the TX initiates a retransmission if the number of allowed retransmissions has not been exceeded;
      ii. If there is a LTE PSCCH/PSSCH transmission, and there is a secondary PSFCH mapping, then wait to receive the HARQ feedback at those resources;
         i. Note, in this case the NR SL devices operating in overlapping resources are provided with multiple PSFCH mappings, composed of a primary mapping and secondary mappings. The primary mapping corresponds to the original PSCCH/PSSCH mapping, while the secondary mappings correspond to additional PSFCH resources;
      iii. If there is an LTE PSCCH/PSSCH transmission, the HARQ feedback is NACK-only and no NACK feedback is received, then the TX UE may assume that RX UE(s) had NACK to send, but did not send it because they also sensed the overlapping LTE PSCCH/PSSCH transmission.

15. In case there are additional reserved resources, then the TX will utilize these resources for the TB retransmission and transition to step 6. In case there are no additional reserved resources, then the TX will have to trigger a new resource selection and therefore will transition to step 5.

### RX Proposed Procedure

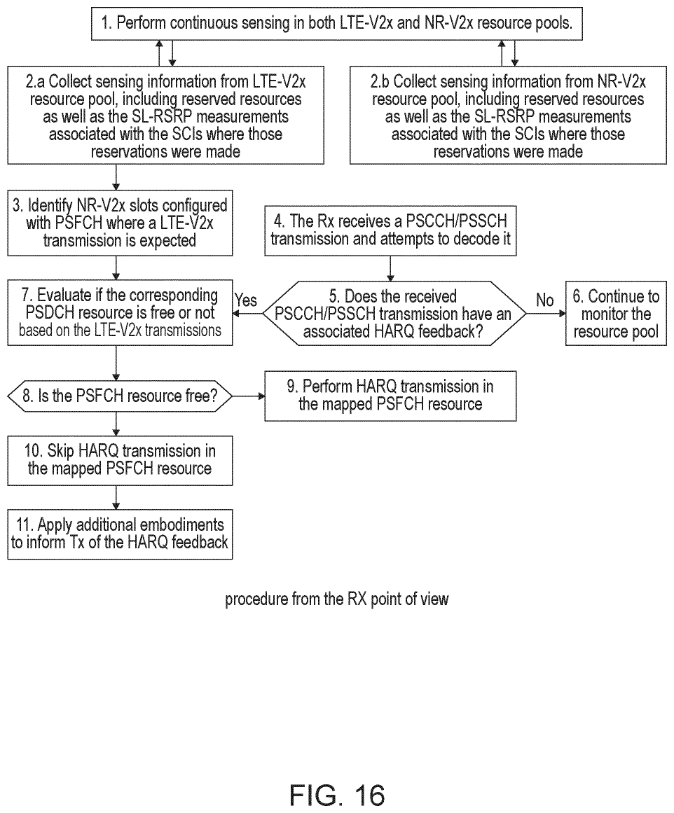

The proposed procedure from the RX point of view is illustrated in FIG. 16 and is composed of the following steps:
1. The RX UE performs continuous sensing in both LTE-V2X and NR-V2X sidelink resource pools;
2. The RX UE collects sensing information:
   a. From the LTE-V2X sidelink resource pool, which includes reserved resources (including subframe, initial sub-channel and number of reserved sub-channels) and RSRP measurements (PSSCH-RSRP) associated with the LTE SCIs where those reservations were made;
   b. From the NR-V2X sidelink resource pool, which includes reserved resources (including slot, initial sub-channel and number of reserved sub-channels) and RSRP measurements (PSCCH-RSRP or PSSCH-RSRP, depending on (pre-)configured parameter sl-RS-ForSensing) associated with the NR SCIs where those reservations were made;
3. Identify in accordance with example embodiments of the invention NR SL slots configured with PSFCH where an overlapping LTE PSCCH/PSSCH transmission is expected. This can be accomplished by the RX performing continuous sensing;
   a. Note that in the case of groupcast, different RX will have different PSFCH resources (e.g., different PRBs) and therefore not all groupcast RX members might suffer an overlap. The RX procedure is assumed to be applied at each RX independently;
4. The RX UE receives an NR PSCCH/PSSCH transmission and attempts to decode it;
5. The RX UE determines if the received SCI requires HARQ feedback;
6. If no HARQ feedback is required, regardless of whether the NR PSSCH payload was decoded or not, the RX UE continues monitoring the resource pool;
7. Evaluate in accordance with example embodiments of the invention if the corresponding PSFCH resource is free or not based on whether it is expected that an LTE PSCCH/PSSCH transmission will take place in the same resource as the PSFCH that is associated with the received NR PSCCH/PSSCH transmission.
   a. This assumes that the RX UE is performing continuous sensing and the goal is to identify mismatch between the sensing at the TX (which led to the selection of a PSCCH/PSSCH resource and the associated PSFCH) and the sensing at the RX;
      i. Note that there might be alternatives to continuous sensing, but this is outside the scope of the solution proposed in this invention.
   b. In accordance with example embodiments of the invention this step can be conditioned on the indication from the TX UE in the SCI (i.e., a 1-bit indication on either 1^{st}-stage SCI or 2^{nd}-stage SCI) indicating whether or not the RX should also evaluate if the PSFCH resource is going to overlap with an LTE PSCCH/PSSCH transmission. Alternatively, the execution of this step can be part of the NR-V2X configuration;
      i. In one example, the RX UE may determine to sense for PSFCH resources if one or more triggers are present. These triggers may be the distance between the RX and TX UEs, the RX UE's speed relative to TX UE, and/or the RX UE's location.
   c. In accordance with example embodiments of the invention the PSFCH resource can be assumed as free if:
      i. The measured RSRP of the LTE SCI is below a (pre-)configured RSRP threshold; or
      ii. The PSFCH resource does not overlap with the LTE PSCCH; or
      iii. The PSFCH resource does not overlap with the LTE PSCCH and the measured RSRP of the LTE SCI is below a configured RSRP threshold;
8. If the PSFCH resource is free, then proceed to step 9;
9. Perform PSFCH transmission in the PSFCH resource associated with the received NR PSCCH/PSSCH;
10. In case the PSFCH was deemed as not free, then the RX UE will skip the HARQ feedback transmission in the PSFCH resource associated with the received NR PSCCH/PSSCH transmission;
11. The following embodiments can then be applied, due to the absence of the transmission of HARQ feedback in the associated PSFCH resource;
   a. The NR SL devices operating in overlapping resources are provided with multiple PSFCH mappings, composed of a primary mapping and secondary mappings. The primary mapping corresponds to the original PSCCH/PSSCH mapping, while the secondary mappings correspond to additional PSFCH resources, which can occur:
      i. At a later time in the overlapping resources, e.g., some PSFCH RBs in later PSFCH symbols have a direct mapping to the original NR PSCCH/PSSCH resource;
      ii. At the same time instant (i.e., the same PSFCH symbol), but in RBs where there is no overlap between LTE PSCCH/PSSCH and NR PSFCH;
      iii. Or a combination thereof;
   b. In accordance with example embodiments of the invention the RX, when taking the role of TX to perform its transmission towards the original TX (e.g., in the case of bi-directional communications), can include in its payload an indication (e.g., in the 2^{nd}-stage SCI or a MAC CE) on whether the TX's previous transmission was decoded successfully or not. This information can then be used by the TX to trigger a retransmission;
      i. In the case of MAC CE or 2^{nd}-stage SCI based HARQ feedback, a timer can be introduced to help the TX UE to decide if it needs to trigger a HARQ retransmission due to lack of HARQ feedback via any of these means;

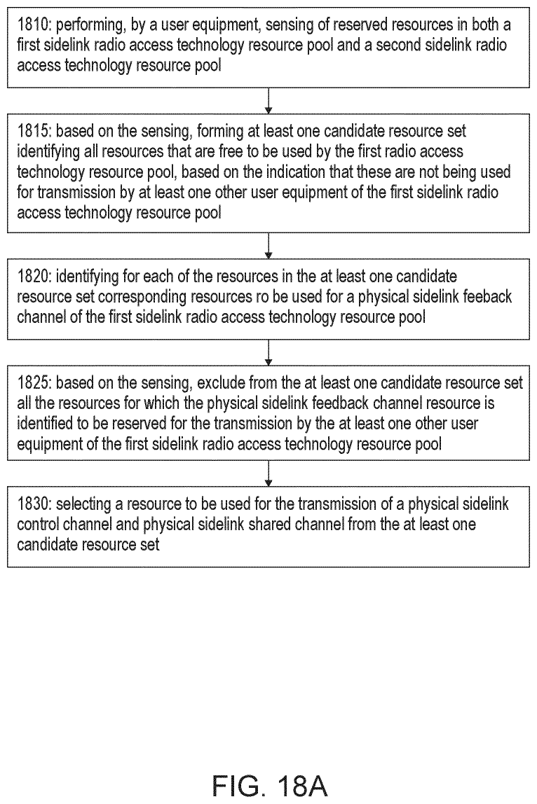

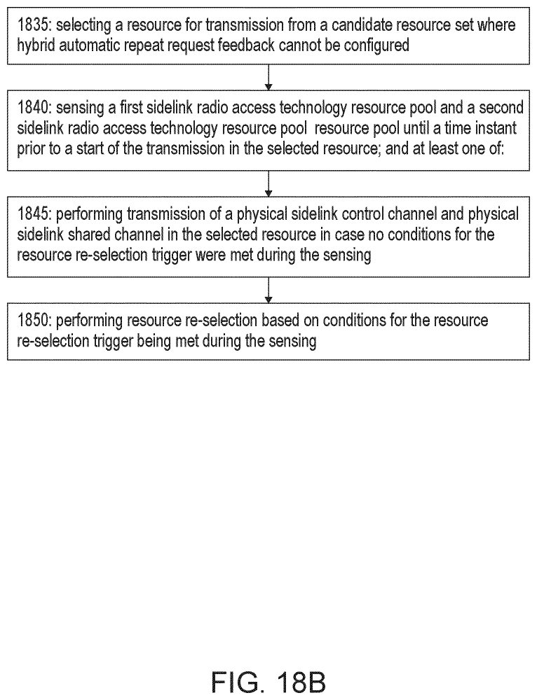

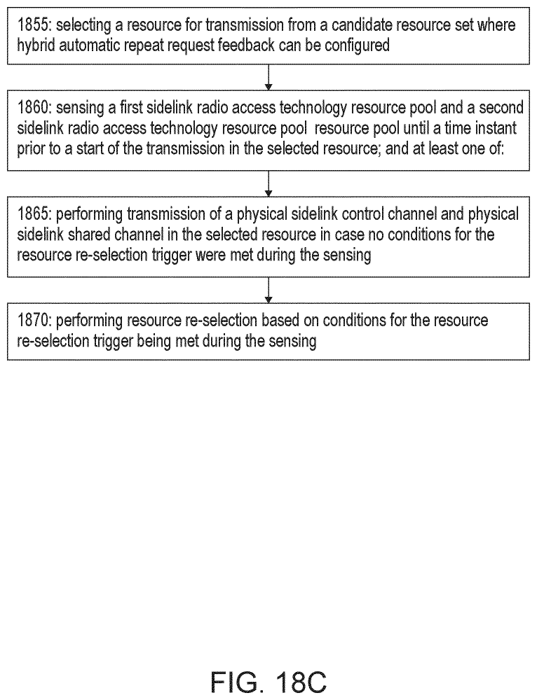

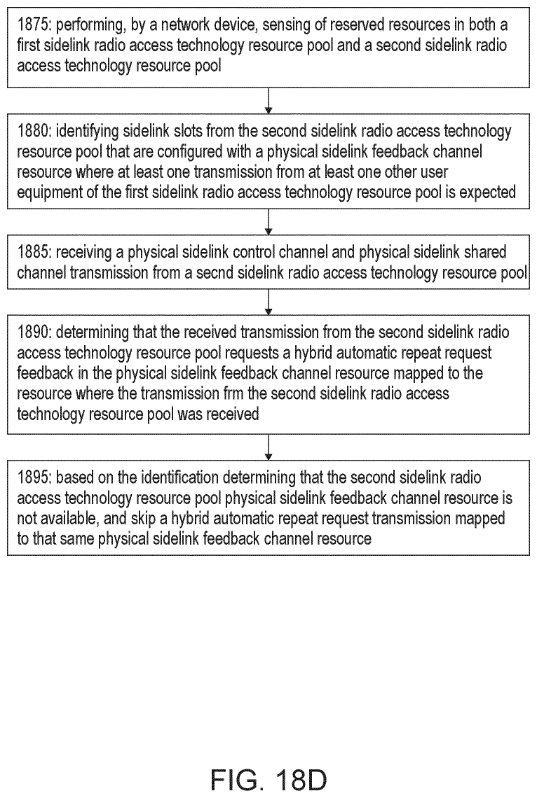

FIG. 18A, 18B, 18C, and FIG. 18D each show a method in accordance with example embodiments of the invention which may be performed by an apparatus.

FIG. 18A illustrates operations which may be performed by a device such as, but not limited to, a sidelink transmitting device (e.g., the UE A, UE B, and/or UE C as in FIG. 17). As shown in step 1810 of FIG. 18A there is performing, by a user equipment, sensing of reserved resources in both a first sidelink radio access technology resource pool and a second sidelink radio access technology resource pool. As shown in step 1815 of FIG. 18A there is, based on the sensing, forming at least one candidate resource set identifying all resources that are free to be used by the first radio access technology resource pool, based on the indication that these are not being used for transmission by at least one other user equipment of the first sidelink radio access technology resource pool. As shown in step 1820 of FIG. 18A there is identifying for each of the resources in the at least one candidate resource set corresponding resources to be used for a physical sidelink feedback channel of the first sidelink radio access technology resource pool. As shown in step 1825 of FIG. 18A there is, based on the sensing, excluding from the at least one candidate resource set all the resources for which the physical sidelink feedback channel resource is identified to be reserved for the transmission by the at least one other user equipment of the first sidelink radio access technology resource pool. Then as shown in step 1830 of FIG. 18A there is selecting a resource to be used for the transmission of a physical sidelink control channel and physical sidelink shared channel from the at least one candidate resource set.

In accordance with the example embodiments as described in the paragraph above, wherein the sensing evaluates if a future resource is indicated to be reserved in a received sidelink control information, in the first sidelink radio access technology resource pool; and further evaluating validity of that reservation based on the measurement of a reference signal received power associated with the received sidelink control information.

In accordance with the example embodiments as described in the paragraphs above, wherein the validity of the resource reservation is made by comparing the measurement of a received reference signal power associated with the received sidelink control information with a first sidelink reference signal received power threshold.

In accordance with the example embodiments as described in the paragraphs above, wherein the sensing, of a physical sidelink feedback channel resource corresponding to a resource in the candidate resource set, evaluates if a physical sidelink feedback resource is indicated to be reserved in a received sidelink control information, in the first sidelink radio access technology resource pool resource pool; and there is further evaluating validity of that reservation based on measurement of a reference signal received power associated with received sidelink control information.

In accordance with the example embodiments as described in the paragraphs above, wherein the validity of the resource reservation is made by comparing the measurement of the reference signal received power associated with the received sidelink control information with a second sidelink reference signal received power threshold.

In accordance with the example embodiments as described in the paragraphs above, wherein the resource exclusion from the at least one candidate resource set is based on sensing that the corresponding physical sidelink feedback channel resource is identified to be reserved for the transmission of at least one other user equipment of the first sidelink radio access technology resource pool, is done in relation to the reference signal received power associated with the received sidelink control information of the transmission of the other user equipment of the first sidelink radio access technology resource pool being above a second sidelink reference signal received power threshold.

In accordance with the example embodiments as described in the paragraphs above, wherein the transmission of at least one other user equipment of the first sidelink radio access technology resource pool is a cooperative awareness message.

In accordance with the example embodiments as described in the paragraphs above, wherein the exclusion is based on identification of an occurrence of at least one of: whether a candidate resource overlaps with a resource indicated as reserved for the upcoming at least one of a first sidelink radio access technology resource pool or a second sidelink radio access technology resource pool physical sidelink control channel and physical sidelink shared channel transmission, or whether an associated at least one physical sidelink feedback channel resource overlaps with a resource indicated as reserved for the upcoming at least one of a first sidelink radio access technology resource pool physical sidelink control channel and physical sidelink shared channel transmission.

In accordance with the example embodiments as described in the paragraphs above, wherein the exclusion identifies that a resource time of the physical sidelink feedback channel resource is not overlapping with transmission of a cooperative awareness message which new radio reception is expected to be receiving using a first sidelink radio access technology resource pool reception counterpart.

In accordance with the example embodiments as described in the paragraphs above, wherein the at least one candidate resource set comprises a first set of resources where hybrid automatic repeat request feedback can be configured and a second set of resources where hybrid automatic repeat request feedback cannot be configured.

In accordance with the example embodiments as described in the paragraphs above, wherein the resources within a candidate resource set of the at least one candidate resource set where hybrid automatic repeat request feedback can be configured, are evaluated based on the sensing of the first sidelink radio access technology resource pool resource pool to have an available associated resource for the physical sidelink shared channel.

In accordance with the example embodiments as described in the paragraphs above, wherein the resources within a candidate resource set of the at least one candidate resource set where hybrid automatic repeat request feedback cannot be configured are evaluated based on the sensing of the first sidelink radio access technology resource pool resource pool not having an available associated resource for the physical sidelink shared channel.

In accordance with the example embodiments as described in the paragraphs above, where the resource is selected from the candidate resource set where hybrid automatic repeat request feedback can be configured, when the transmitted payload requires hybrid automatic repeat request feedback; otherwise, the resource is selected from the candidate resource set where hybrid automatic repeat request cannot be configured.

In accordance with the example embodiments as described in the paragraphs above, wherein the first sidelink radio access technology resource pool and a second sidelink radio access technology resource pool overlap each other in at least one of time or frequency.

A non-transitory computer-readable medium (MEM 10B, MEM 5B, and/or MEM 13B as in FIG. 17) storing program code (PROG 10C, PROG 5C, and/or PROG 13C as in FIG. 17), the program code executed by at least one processor (DP 10A, DP 5A, and/or DP 13A as in FIG. 17) to perform the operations as at least described in the paragraphs above.

In accordance with an example embodiment of the invention as described above there is an apparatus comprising: means for performing (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17), by a user equipment (UE A, UE B, and/or UE C as in FIG. 17), sensing (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) of reserved resources in both a first sidelink radio access technology resource pool and a second sidelink radio access technology resource pool; means, based on the sensing, for forming (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) at least one candidate resource set identifying all resources that are free to be used by the first radio access technology resource pool, based on the indication that these are not being used for transmission by at least one other user equipment of the first sidelink radio access technology resource pool; means for identify (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) for each of the resources in the at least one candidate resource set corresponding resources to be used for a physical sidelink feedback channel of the first sidelink radio access technology resource pool; means, based on the sensing, for excluding (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) from the at least one candidate resource set all the resources for which the physical sidelink feedback channel resource is identified to be reserved for the transmission by the at least one other user equipment of the first sidelink radio access technology resource pool; and means for selecting (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) a resource to be used for the transmission of a physical sidelink control channel and physical sidelink shared channel from the at least one candidate resource set.

In the example aspect of the invention according to the paragraph above, wherein at least the means for performing, forming, identifying, and selecting comprises a non-transitory computer readable medium [MEM 10B, MEM 5B, and/or MEM 13B as in FIG. 17] encoded with a computer program [PROG 10C, PROG 5C, and/or PROG 13C as in FIG. 17] executable by at least one processor [DP 10A, DP 5A, and/or DP 13A as in FIG. 17].

FIG. 18B illustrates operations which may be performed by a device such as, but not limited to, a sidelink reception device (e.g., the UE A, UE B, and/or UE C as in FIG. 17). As shown in step 1835 of FIG. 18B there is selecting a resource for transmission from a candidate resource set where hybrid automatic repeat request feedback cannot be configured. As shown in step 1840 of FIG. 18B there is sensing a first sidelink radio access technology resource pool and a second sidelink radio access technology resource pool resource pool until a time instant prior to a start of the transmission in the selected resource; and at least one of: as shown in step 1845 of FIG. 18B performing transmission of a physical sidelink control channel and physical sidelink shared channel in the selected resource in case no conditions for the resource re-selection trigger were met during the sensing, or as shown in step 1850 of FIG. 18B there is performing resource re-selection based on conditions for the resource re-selection trigger being met during the sensing.

In accordance with the example embodiments as described in the paragraph above, wherein the conditions for the resource re-selection trigger are based on at least one of: the selected resource was identified to be reserved for the transmission of a physical sidelink control channel, or physical sidelink shared channel of a first sidelink radio access technology resource pool.

A non-transitory computer-readable medium (MEM 10B, MEM 5B, and/or MEM 13B as in FIG. 17) storing program code (PROG 10C, PROG 5C, and/or PROG 13C as in FIG. 17), the program code executed by at least one processor (DP 10A, DP 5A, and/or DP 13A as in FIG. 17) to perform the operations as at least described in the paragraphs above.

In accordance with an example embodiment of the invention as described above there is an apparatus comprising: means for selecting (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) a resource for transmission from a candidate resource set where hybrid automatic repeat request feedback cannot be configured; means for sensing (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) a first sidelink radio access technology resource pool and a second sidelink radio access technology resource pool resource pool until a time instant prior to a start of the transmission in the selected resource; and means for at least one of: performing (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) transmission of a physical sidelink control channel and physical sidelink shared channel in the selected resource in case no conditions for the resource re-selection trigger were met during the sensing, or performing (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) resource re-selection based on conditions for the resource re-selection trigger being met during the sensing.

In the example aspect of the invention according to the paragraph above, wherein at least the means for selecting, sensing, and performing comprises a non-transitory computer readable medium [MEM 10B, MEM 5B, and/or MEM 13B as in FIG. 17] encoded with a computer program [PROG 10C, PROG 5C, and/or PROG 13C as in FIG. 17] executable by at least one processor [DP 10A, DP 5A, and/or DP 13A as in FIG. 17].

FIG. 18C illustrates operations which may be performed by a device such as, but not limited to, a sidelink reception device (e.g., the UE A, UE B, and/or UE C as in FIG. 17). As shown in step 1855 of FIG. 18C there is selecting a resource for transmission from a candidate resource set where hybrid automatic repeat request feedback can be configured. As shown in step 1860 of FIG. 18C there is sensing the first sidelink radio access technology resource pool resource pools until the time instant prior to the start of the transmission in the selected resource. As shown in step 1865 of FIG. 18C there is performing transmission of a physical sidelink control channel and physical sidelink shared channel in the selected resource based on no conditions for the resource re-selection trigger being met during the sensing. Then as shown in step 1870 of FIG. 18C there is performing resource re-selection based on conditions for the resource re-selection trigger being met during the sensing.

In accordance with the example embodiments as described in the paragraph above, where the conditions for the resource re-selection trigger are at least one of: the selected resource was identified to be reserved for the transmission of a physical sidelink control channel or physical sidelink shared channel of a first sidelink radio access technology resource pool, wherein the physical sidelink feedback channel resource associated to the selected resource was identified to be reserved for the transmission of a physical sidelink control channel or physical sidelink shared channel of the first sidelink radio access technology resource pool.

In accordance with the example embodiments as described in the paragraphs above, where upon determining that the conditions for the resource reselection trigger are met for the case that the physical sidelink feedback channel resource associated to the selected resource was identified to be reserved for the transmission of a physical sidelink control channel or physical sidelink shared channel of a first sidelink radio access technology resource pool, determine to not request hybrid automatic repeat request feedback and proceed with the transmission on the initially selected resource.

A non-transitory computer-readable medium (MEM 10B, MEM 5B, and/or MEM 13B as in FIG. 17) storing program code (PROG 10C, PROG 5C, and/or PROG 13C as in FIG. 17), the program code executed by at least one processor (DP 10A, DP 5A, and/or DP 13A as in FIG. 17) to perform the operations as at least described in the paragraphs above.

In accordance with an example embodiment of the invention as described above there is an apparatus comprising: means for selecting (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) a resource for transmission from a candidate resource set where hybrid automatic repeat request feedback can be configured; means for sensing (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) the first sidelink radio access technology resource pool resource pools until the time instant prior to the start of the transmission in the selected resource; means for performing (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) transmission of a physical sidelink control channel and physical sidelink shared channel in the selected resource based on no conditions for the resource re-selection trigger being met during the sensing; and means for performing (TRANS 10D, TRANS 5D, and/or TRANS 13D; MEM 10B, MEM 5B, and/or MEM 13B; PROG 10C, PROG 5C, and/or PROG 13C; and DP 10A, DP 5A, and/or DP 13A as in FIG. 17) resource re-selection based on conditions for the resource re-selection trigger being met during the sensing.

In the example aspect of the invention according to the paragraph above, wherein at least the means for selecting, sensing, and performing comprises a non-transitory computer readable medium [MEM 10B, MEM 5B, and/or MEM 13B as in FIG. 17] encoded with a computer program [PROG 10C, PROG 5C, and/or PROG 13C as in FIG. 17] executable by at least one processor [DP 10A, DP 5A, and/or DP 13A as in FIG. 17].

FIG. 18D illustrates operations which may be performed by a device such as, but not limited to, a network device (e.g., the NN 12 as in FIG. 17). As shown in step 1875 of FIG. 18D there is performing, by a network device, sensing of reserved resources in both a first sidelink radio access technology resource pool and second sidelink radio access technology resource pool resource pool. As shown in step 1880 of FIG. 18D there is identifying sidelink slots from the second sidelink radio access technology resource pool that are configured with a physical sidelink feedback channel resource where at least one transmission from at least one other user equipment of the first sidelink radio access technology resource pool is expected. As shown in step 1885 of FIG. 18D there is receiving a physical sidelink control channel and physical sidelink shared channel transmission from a second sidelink radio access technology resource pool. As shown in step 1890 of FIG. 18D there is determining that the received transmission from the second sidelink radio access technology resource pool requests a hybrid automatic repeat request feedback in the physical sidelink feedback channel resource mapped to the resource where the transmission from the second sidelink radio access technology resource pool was received. Then as shown in step 1895 of FIG. 18D there is there is wherein based on the identification determining that the second sidelink radio access technology resource pool physical sidelink feedback channel resource is not available, skipping a hybrid automatic repeat request transmission mapped to that same physical sidelink feedback channel resource.

In accordance with the example embodiments as described in the paragraph above, wherein the sensing evaluates if a future resource is indicated to be reserved in a received sidelink control information, in at least one of the first radio access technology resource pool or second sidelink radio access technology resource pool resource pool; and further evaluating the validity of that reservation based on the measurement of a reference signal received power associated with the received sidelink control information.

In accordance with the example embodiments as described in the paragraphs above, wherein the sensing, of a physical sidelink feedback channel resource corresponding to a resource in at least one candidate resource set, evaluates if a the physical sidelink feedback channel resource is indicated to be reserved in a received sidelink control information, in the first sidelink radio access technology resource pool resource pool; and further evaluating the validity of that reservation based on the measurement of a reference signal received power associated with the received sidelink control information.

In accordance with the example embodiments as described in the paragraphs above, wherein based on determining that the second sidelink radio access technology resource pool physical sidelink feedback channel resource is not available, skipping a hybrid automatic repeat request transmission mapped to that same physical sidelink feedback channel resource based on an indication in the sidelink control information associated with the received physical sidelink control channel and physical sidelink shared channel transmission from a second sidelink radio access technology resource pool.

In accordance with the example embodiments as described in the paragraphs above, wherein the physical sidelink feedback channel resource can be assumed to be available based on at least one of: a measured reference signal received power of first sidelink radio access technology resource pool transmission associated sidelink control information is below a pre-configured threshold, the physical sidelink feedback channel does not overlap with a first sidelink radio access technology resource pool transmission physical sidelink control channel, or the physical sidelink feedback channel does not overlap with the first sidelink radio access technology resource pool transmission physical sidelink control channel and a measured reference signal received power of the first sidelink radio access technology resource pool transmission associated evolution sidelink control information is below a pre-configured threshold.

A non-transitory computer-readable medium (MEM 12B as in FIG. 17) storing program code (PROG 12C as in FIG. 17), the program code executed by at least one processor (DP 14A as in FIG. 17) to perform the operations as at least described in the paragraphs above.

In accordance with an example embodiment of the invention as described above there is an apparatus comprising: means for performing (TRANS 12D, MEM 14B, PROG 14C, and DP 14A as in FIG. 17), by a network device (NN 12 as in FIG. 17), sensing (TRANS 12D, MEM 14B, PROG 14C, and DP 14A as in FIG. 17) of reserved resources in both a first sidelink radio access technology resource pool and second sidelink radio access technology resource pool resource pool; means for identifying (TRANS 12D, MEM 14B, PROG 14C, and DP 14A as in FIG. 17) sidelink slots from the second sidelink radio access technology resource pool that are configured with a physical sidelink feedback channel resource where at least one transmission from at least one other user equipment of the first sidelink radio access technology resource pool is expected; means for receiving (TRANS 12D, MEM 14B, PROG 14C, and DP 14A as in FIG. 17) a physical sidelink control channel and physical sidelink shared channel transmission from a second sidelink radio access technology resource pool; means for determining (TRANS 12D, MEM 14B, PROG 14C, and DP 14A as in FIG. 17) that the received transmission from the second sidelink radio access technology resource pool requests a hybrid automatic repeat request feedback in the physical sidelink feedback channel resource mapped to the resource where the transmission from the second sidelink radio access technology resource pool was received; and means, based on the identification, for determining (TRANS 12D, MEM 14B, PROG 14C, and DP 14A as in FIG. 17) that the second sidelink radio access technology resource pool physical sidelink feedback channel resource is not available, and skip a hybrid automatic repeat request transmission mapped to that same physical sidelink feedback channel resource.

In the example aspect of the invention according to the paragraph above, wherein at least the means for performing, identifying, receiving, and determining comprises a non-transitory computer readable medium [MEM 14B as in FIG. 17] encoded with a computer program [PROG 14C as in FIG. 17] executable by at least one processor [DP 14A as in FIG. 17].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” as may be used herein is to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-28. (canceled)

29. An apparatus, comprising:
at least one processor; and
at least one memory, the at least one memory storing instructions, that when executed by the at least one processor, cause the apparatus to:
perform, by a user equipment, sensing of reserved resources in both a first sidelink radio access technology resource pool and a second sidelink radio access technology resource pool;
based on the sensing, form at least one candidate resource set identifying all resources that are free to be used by the first radio access technology resource pool, based on an indication that these are not being used for transmission by at least one other user equipment of the second sidelink radio access technology resource pool;
identify for each of the resources in the at least one candidate resource set corresponding resources to be used for a physical sidelink feedback channel of the first sidelink radio access technology resource pool;
based on the sensing, exclude from the at least one candidate resource set all the resources for which the physical sidelink feedback channel resource is identified to be reserved for the transmission by the at least one other user equipment of the second sidelink radio access technology resource pool; and
select a resource to be used for the transmission of a physical sidelink control channel and physical sidelink shared channel from the at least one candidate resource set.

30. The apparatus according to claim 29, wherein the sensing evaluates if a future resource is indicated to be reserved in a received sidelink control information, in the first sidelink radio access technology resource pool and/or in the second sidelink radio access technology; and wherein the instructions, when executed by the at least one processor, further cause the apparatus to evaluate a validity of the reservation based on a measurement of a reference signal received power associated with the received sidelink control information.

31. The apparatus according to claim 30, wherein the validity of the resource reservation is made by comparing the measurement of a received reference signal power associated with the received sidelink control information with a first sidelink reference signal received power threshold.

32. The apparatus according to claim 29, wherein the sensing, of a physical sidelink feedback channel resource corresponding to a resource in the candidate resource set, evaluates if a physical sidelink feedback resource is indicated to be reserved in a received sidelink control information, in the first sidelink radio access technology resource pool resource pool; and wherein the instructions, when executed by the at least one processor, further cause the apparatus to further evaluate a validity of the reservation based on a measurement of a reference signal received power associated with the received sidelink control information.

33. The apparatus according to claim 32, wherein the validity of the resource reservation is made by comparing the measurement of the reference signal received power associated with the received sidelink control information with a second sidelink reference signal received power threshold.

34. The apparatus according to claim 29, wherein the resource exclusion from the at least one candidate resource set is based on sensing that the corresponding physical sidelink feedback channel resource is identified to be reserved for the transmission of at least one other user equipment of the second sidelink radio access technology resource pool, is done in relation to the reference signal received power associated with the received sidelink control information of the transmission of the other user equipment of the second sidelink radio access technology resource pool being above a second sidelink reference signal received power threshold.

35. The apparatus according to claim 29, wherein the transmission of the at least one other user equipment of the second sidelink radio access technology resource pool is a cooperative awareness message.

36. The apparatus according to claim 29, wherein the exclusion is based on identification of an occurrence of at least one of:
whether a candidate resource overlaps with a resource indicated as reserved for the upcoming at least one of a first sidelink radio access technology resource pool or a second sidelink radio access technology resource pool physical sidelink control channel and physical sidelink shared channel transmission, or whether an associated at least one physical sidelink feedback channel resource overlaps with a resource indicated as reserved for the upcoming at least one of a first sidelink radio access technology resource pool physical sidelink control channel and physical sidelink shared channel transmission.

37. The apparatus according to claim 33, wherein the exclusion identifies that a resource time of the physical sidelink feedback channel resource is not overlapping with transmission of a cooperative awareness message which new radio reception is expected to be receiving using a first sidelink radio access technology resource pool reception counterpart.

38. The apparatus according to claim 29, wherein the at least one candidate resource set comprises a first set of resources where hybrid automatic repeat request feedback can be configured and a second set of resources where hybrid automatic repeat request feedback cannot be configured.

39. The apparatus according to claim 38, wherein the resources within a candidate resource set of the at least one candidate resource set where hybrid automatic repeat request feedback can be configured, are evaluated based on the sensing of the first sidelink radio access technology resource pool resource pool to have an available associated resource for the physical sidelink shared channel.

40. The apparatus according to claim 38, wherein the resources within a candidate resource set of the at least one candidate resource set where hybrid automatic repeat request feedback cannot be configured are evaluated based on the sensing of the first sidelink radio access technology resource pool resource pool not having an available associated resource for the physical sidelink shared channel.

41. The apparatus according to claim 38, wherein the resource is selected from the candidate resource set where hybrid automatic repeat request feedback can be configured, when the transmitted payload requires hybrid automatic repeat request feedback; otherwise, the resource is selected from the candidate resource set where hybrid automatic repeat request cannot be configured.

42. The apparatus according to claim 29, wherein the first sidelink radio access technology resource pool and the second sidelink radio access technology resource pool overlap each other in at least one of time or frequency.

43. A method, comprising:
performing, by a user equipment, sensing of reserved resources in both a first sidelink radio access technology resource pool and a second sidelink radio access technology resource pool;
based on the sensing, forming at least one candidate resource set identifying all resources that are free to be used by the first radio access technology resource pool, based on an indication that these are not being used for transmission by at least one other user equipment of the second sidelink radio access technology resource pool;
identifying for each of the resources in the at least one candidate resource set corresponding resources to be used for a physical sidelink feedback channel of the first sidelink radio access technology resource pool;
based on the sensing, excluding from the at least one candidate resource set all the resources for which the physical sidelink feedback channel resource is identified to be reserved for the transmission by the at least one other user equipment of the second sidelink radio access technology resource pool; and
selecting a resource to be used for the transmission of a physical sidelink control channel and physical sidelink shared channel from the at least one candidate resource set.

44. The method according to claim 43, wherein the sensing evaluates if a future resource is indicated to be reserved in a received sidelink control information, in the first sidelink radio access technology resource pool and/or in the second sidelink radio access technology; and further evaluating a validity of the reservation based on a measurement of a reference signal received power associated with the received sidelink control information.

45. The method according to claim 44, wherein the validity of the resource reservation is made by comparing the measurement of a received reference signal power associated with the received sidelink control information with a first sidelink reference signal received power threshold.

46. The method according to claim 43, wherein the sensing, of a physical sidelink feedback channel resource corresponding to a resource in the candidate resource set, evaluates if a physical sidelink feedback resource is indicated to be reserved in a received sidelink control information, in the first sidelink radio access technology resource pool resource pool; and the method comprising:
further evaluating a validity of the reservation based on a measurement of a reference signal received power associated with the received sidelink control information.

47. The method according to claim 46, wherein the validity of the resource reservation is made by comparing the measurement of the reference signal received power associated with the received sidelink control information with a second sidelink reference signal received power threshold.

48. The method according to claim 43, wherein the resource exclusion from the at least one candidate resource set is based on sensing that the corresponding physical sidelink feedback channel resource is identified to be reserved for the transmission of at least one other user equipment of the second sidelink radio access technology resource pool, is done in relation to the reference signal received power associated with the received sidelink control information of the transmission of the other user equipment of the second sidelink radio access technology resource pool being above a second sidelink reference signal received power threshold.
